(19) United States
(12) Patent Application Publication
(10) Pub. No.: US 2026/0309559 A1
(43) Pub. Date: Oct. 8, 2026

(54) FORCE SENSOR AND METHODS OF MAKING AND USING SAME

(71) Applicant: Organic Robotics Corporation, Ithaca, NY (US)

(72) Inventors: Ilayda Samilgil, Somerville, MA (US); Robert Shepherd, Ithaca, NY (US); Courtney Semkewyc, Minnesott Beach, NC (US); Melanie Lyons, Maine, NY (US); Carl Hebert, Mendon, MA (US)

(21) Appl. No.: 19/173,681

(22) Filed: Apr. 8, 2025

(51) Int. Cl. G01L 1/24; G01L 5/00

(52) U.S. Cl. CPC G01L 1/243; G01L 5/0052

(57) ABSTRACT

A system includes a fiber optic element configured to be arranged in an object, such as a graspable object, a light source configured to provide a light signal to the fiber optic element, and a light detector. The fiber optic element attenuates the light signal based on a force applied to the graspable object, and the light detector is configured to receive the light signal as attenuated by the fiber optic element. The light detector also generates an output signal based on the received light signal. The system may include a guide to define the path of the fiber optic element under an outer surface of the graspable object. The object may include a target or backstop, or a graspable object such as, for example, a tool, sports ball, or handle, to which a force may be applied.

### INTRODUCTION

The present disclosure is directed to systems and methods for sensing force and, more particularly, fiber optic-based sensor systems for sensing force applied over an area.

### SUMMARY

In some embodiments, the present disclosure is directed to a system that includes a fiber optic element configured to be arranged under a surface of an object (e.g., in a graspable object, target object, or other object to which forces are applied), a light source configured to provide a light signal to the fiber optic element, and a light detector. The fiber optic element attenuates the light signal based on a force applied to the object. The light detector is configured to receive the light signal as attenuated by the fiber optic element, and generate an output signal based on the received light signal. In some embodiments, the system includes a control unit coupled to the light source and that is configured to cause the light source to provide the light signal to a first position of the fiber optic element. For example, in some embodiments, the light signal is a modulated signal, and the control unit causes the light source to provide the modulated signal. In some embodiments, the system includes processing circuitry configured to receive the output signal from the at least one detector, and sample the output signal at a rate of at least 1 kHz.

In some embodiments, the object is a graspable object (e.g., such as a sports ball, a hand-held tool, or otherwise an apparatus having a handle). In some embodiments, the system includes a guide configured to be arranged under an outer surface of the object and to define the path of the fiber optic element. In some embodiments, the guide includes a channel, and the channel is configured to accommodate the fiber optic element along its length.

In some embodiments, the light source is arranged at a first end of the fiber optic element, and the light detector is arranged at a second end of the fiber optic element. For example, the light source may provide the light signal to a first end of the fiber optic element, the light signal be attenuated along the length of the fiber optic element (e.g., by properties of the element which may vary based on an applied force), and the light detector may detect the attenuated light signal at the other end of the element. In some embodiments, the light source is arranged at a first end of the fiber optic element, and the light detector is arranged at a position along the fiber optic element between the first end and a second end. For example, the light source may provide the light signal to a first end of the fiber optic element, the light signal be attenuated along the length of the fiber optic element (e.g., by properties of the element which may vary based on an applied force), and the light detector may detect light from a side of the element.

In some embodiments, the system includes processing circuitry coupled to the light source and to the light detector. In some embodiments, the system includes a port coupled to the processing circuitry that is configured to interface to an external system such that data may be transferred between the processing circuitry and the external system.

In some embodiments, the present disclosure is directed to an object that includes an outer surface, a plurality of fiber optic elements arranged under the outer surface, a plurality of light sources each configured to provide a respective light signal to a respective fiber optic element, and a plurality of light detectors. For example, each respective fiber optic element attenuates the respective light signal based on a force applied to the object. In a further example, the plurality of light detectors are each configured to receive the respective light signal as attenuated by the respective fiber optic element, and generate a respective output signal based on the respective received light signal. In some embodiments, each respective fiber optic element has a respective predetermined shape and is configured to attenuate a respective intensity of the respective light signal when the object is gripped. In some embodiments, the object includes a guide arranged under the outer surface that defines each respective predetermined shape. In some embodiments, the plurality of fiber optic elements are arranged such that a grip force causes to be attenuated simultaneously a respective intensity of each respective light signal in a set of fiber optic elements of the plurality of fiber optic elements. In some embodiments, a first set of fiber optic elements of the plurality of fiber optic elements is oriented in a first direction, and a second set of fiber optic elements of the plurality of fiber optic elements is oriented in a second direction at a minor angle of intersection less than 90°. For example, the first and second sets of fiber optic elements may be arranged in a cris-cross pattern or a weave pattern. In some embodiments, the object includes a guide having a plurality of holes configured to accommodate ends of the plurality fiber optic elements. In some embodiments, the object includes processing circuitry coupled to the plurality of light sources and to the plurality of light detectors. In some embodiments, the object includes a port coupled to the processing circuitry that is configured to interface to an external system such that data may be transferred between the processing circuitry and the external system.

In some embodiments, the present disclosure is directed to method including providing a plurality of light signals to a plurality of fiber optic elements arranged in an object using a plurality of light sources, receiving the plurality of light signals at a plurality of light detectors as attenuated by the plurality of fiber optic elements, and generating a plurality of output signals using the plurality of light detectors based on the plurality of received light signals. For example, the plurality of fiber optic elements attenuate the plurality of light signals based on a force applied to the object. In some embodiments, the method includes determining, using processing equipment, one or more force values based on the plurality of output signals, where the one or more force values correspond to the force applied to the object. In some embodiments, an external device includes first processing equipment, the object includes second processing equipment, and the first processing equipment is configured to communicate with the second processing equipment. In some such embodiments, the method includes storing sampled data corresponding to the plurality of output signals in memory storage of the second processing equipment, and transmitting the sampled data from the memory storage to the first processing equipment.

### BRIEF DESCRIPTION OF THE DRAWINGS

The present disclosure, in accordance with one or more various embodiments, is described in detail with reference to the following figures. The drawings are provided for purposes of illustration only and merely depict illustrative embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

FIG. 1 shows two cross-sectional views of an illustrative system having sensors, implemented as a baseball, in accordance with some embodiments of the present disclosure;

FIG. 2 shows several views of an illustrative guide for forming a fiber sensor grid, in accordance with some embodiments of the present disclosure;

FIG. 3 shows a top view and a perspective view of an illustrative fiber optic sensor grid with rhombus spacing, in accordance with some embodiments of the present disclosure;

FIG. 4 shows a top view and a perspective view of an illustrative fiber optic sensor grid with rectangular spacing, in accordance with some embodiments of the present disclosure;

FIG. 5 shows a top view and a perspective view of an illustrative fiber optic sensor grid with an uneven grid spacing, in accordance with some embodiments of the present disclosure;

FIG. 6 shows a top view of an illustrative fiber optic sensor grid having a differing number of sensor channels in first and second directions along a grid space, in accordance with some embodiments of the present disclosure;

FIG. 7 shows several views of an illustrative guide with embedded channels to weave fibers in a fiber grid, in accordance with some embodiments of the present disclosure;

FIG. 8 shows an illustrative guide for forming grid arrangements on both hemispheres of a ball, in accordance with some embodiments of the present disclosure;

FIG. 9 shows an illustrative assembled force sensing baseball, in accordance with some embodiments of the present disclosure;

FIG. 10 shows an interior of an illustrative ball having one hemisphere of sensing capabilities with two layers of a fiber sensor grid, in accordance with some embodiments of the present disclosure;

FIG. 11 shows an illustrative interior support enclosure to fiber sensor grid, in accordance with some embodiments of the present disclosure;

FIG. 12 shows a perspective view of an illustrative fiber sensing grid interfacing optoelectronics, in accordance with some embodiments of the present disclosure;

FIG. 13 shows a side view of illustrative sensor channels interfacing to optoelectronics at a side, in accordance with some embodiments of the present disclosure;

FIG. 14 shows an illustrative partially assembled spherical grid populated with fiber sensors, in accordance with some embodiments of the present disclosure;

FIG. 15 shows a side view of the illustrative assembled spherical grid of FIG. 14 with one hemisphere populated, in accordance with some embodiments of the present disclosure;

FIG. 16 shows plots of illustrative data output from processing circuitry during a throw of the ball, in accordance with some embodiments of the present disclosure;

FIG. 17 shows plots of illustrative fiber data and an illustrative corresponding heat map, in accordance with some embodiments of the present disclosure;

FIG. 18 shows an illustrative force heat map projected on a single hemisphere, in accordance with some embodiments of the present disclosure;

FIG. 19 shows an illustrative example of a baseball with the sensing hemisphere located for pitch grip pressure sensing, in accordance with some embodiments of the present disclosure;

FIG. 20 shows illustrative examples of calibration methods, using spikes to create known strains or applying a known force, in accordance with some embodiments of the present disclosure;

FIG. 21 is a block diagram of an illustrative system for detecting applied force, in accordance with some embodiments of the present disclosure;

FIG. 22 is a flowchart of an illustrative process for making and using a system for detecting applied force, in accordance with some embodiments of the present disclosure;

FIG. 23 shows a perspective view of illustrative processing equipment including a communications interface, in accordance with some embodiments of the present disclosure;

FIG. 24 shows a perspective view of components of an illustrative instrumented system, including the processing equipment of FIG. 23, in accordance with some embodiments of the present disclosure;

FIG. 25 shows illustrative plots of force information determined using an instrumented system, in accordance with some embodiments of the present disclosure;

FIG. 26 shows an illustrative arrangement of fibers in which the fibers to not intersect, in accordance with some embodiments of the present disclosure;

FIG. 27 shows an illustrative arrangement of fibers on an outer surface of a handle grip, in accordance with some embodiments of the present disclosure; and

FIGS. 28-30 show a sequence of illustrative responses from a fiber grid arranged in a target region, including heat maps, in accordance with some embodiments of the present disclosure.

### DETAILED DESCRIPTION

In some embodiments, the present disclosure is directed to a system for sensing grip force applied to a surface. The surface may include an outer surface of a handle, a tool, a ball (e.g., a sports ball), a target area or region (e.g., configured to receive force from a moving object), or any other suitable object over which force may be applied. In some embodiments, for example, the present disclosure is directed to measuring a grip force that an athlete places on equipment over time, thus providing insight into how they are manipulating their equipment and their corresponding performance metrics. In some embodiments, the present disclosure is directed at sensing regions which may undergo force interactions (e.g., a back stop for a ball, a target for a moving object to impact, or other suitable surfaces that receive other than grip forces).

To illustrate, this information may be useful in most sports, but especially baseball, for example, where there may be a gap in knowledge when it comes to the amount of force or pressure that a player imparts on the ball when they throw. This information is important to understand and manipulate the trajectory of the ball as it travels through the air. Determining the force or pressure placed on the ball by the user's fingers may provide information elucidating the reason pitches move in certain ways, serve as a marker for injury or fatigue, or a combination thereof. For example, the systems of the present disclosure may provide the ability to improve player performance and help injury prevention, while also filling a knowledge gap in pitch design. While some approaches may use a tri-axial force transducer embedded in a ball to read finger force, this may require a pitcher to place their finger on the location of the sensor, thus limiting grip options. Additionally, such an approach may only be able to collect data from a single finger at a time, may be limited to a single reading at the fingertip, and may require that data be read via a tether to the wrist. Accordingly, in some embodiments, the present disclosure provides a wireless device, allowing for high-speed data collection, localization of finger placement on the ball, an ability to sense differences in force across the finger, and the ability to collect data from multiple fingers simultaneously.

In some embodiments, the sensor systems of the present disclosure include an elastomer sensor arrangement configured to measure force over time. The arrangement may be designed in various shapes and sizes to be molded into sporting equipment such as baseballs, bats, gun stocks or grips, tools, rackets, clubs, targets or backstops, or any other suitable object, for example. For example, in some embodiments, the system include at least one fiber optic sensor, which may include a polymer fiber optic element or a combination of a polymer fiber optic elements, at least one light source, and at least one light sensor (e.g., a photo diode, photo transistor, photo resistor, CMOS imager, or any other suitable detector or combination of detectors thereof). In some embodiments, a light source is arranged to couple light into the fiber optic, a force (e.g., such as a grip force or force arising from momentum change from a moving object) is applied to the fiber optic element, and the force modulates a light intensity that is measured by the light sensor (e.g., as a modulated light signal based on the light from the light source). Processing circuitry, such as a printed circuit board (PCB), may be included in the package to detect and process signals (e.g., of detected light as modulated by the fiber optic elements). In some embodiments, the elastomer sensing array of the present disclosure may be formed into any suitable shape, size, and design, including that of a baseball, for example. It will be understood that while the present disclosure may be applied to a baseball as an illustrative example, the force sensing systems and methods of the present disclosure are applicable to any object or surface that may receive an applied force.

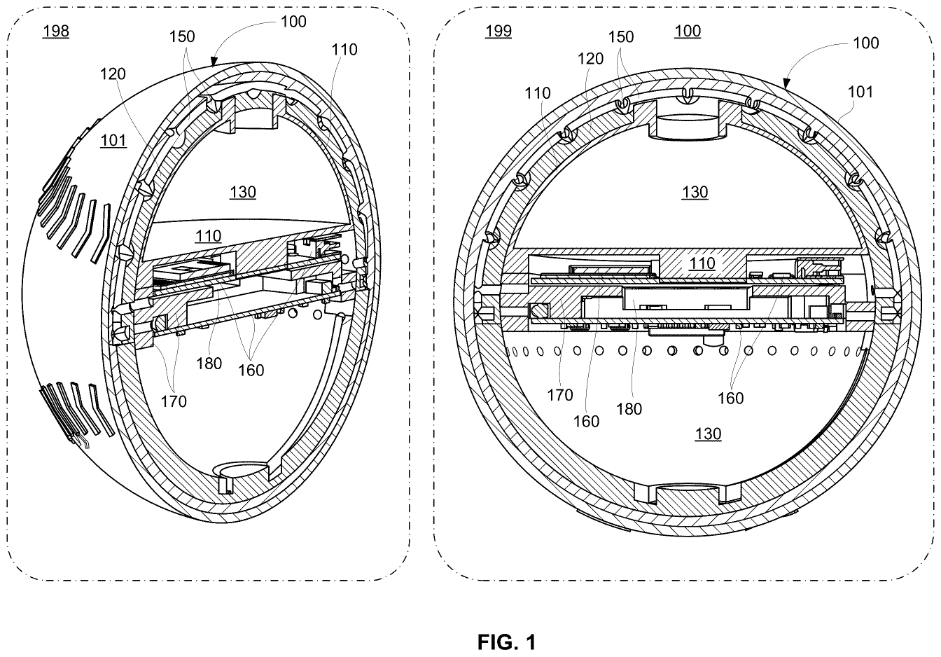

FIG. 1 shows two cross-sectional views of illustrative system 100 having sensors, implemented as a baseball, in accordance with some embodiments of the present disclosure. Panel 198 shows a perspective view of the cross-section, while panel 199 shows a face view of the cross-section. As illustrated, system 100 includes outer layer 101 (e.g., including leather and seams), support enclosure 110, a plurality of fiber optic sensors 150 (e.g., arranged in a grid), guide 120, foam 130 (e.g., filling in a cavity within support enclosure 110 and other voids, although foam 130 may be omitted in some embodiments), processing circuitry 160 (e.g., or “processing equipment” that may include one or more PCBs), enclosure 170 (e.g., to enclose processing circuitry 160), and power supply 180 (e.g., one or more batteries). Power supply 180 may include one or more batteries arranged in a central region of enclosure 170 with processing circuitry 160 arranged adjacent (e.g., one or more PCBs arranged on top of one or more batteries). In some embodiments, support enclosure 110 is filled with a material such as a foam of a predetermined density (e.g., a polyurethane foam of density 8 lb/ft³). For example, support enclosure 110 is configured to serve as a lid for enclosure 170 and function as an internal structural support for system 100. As illustrated, system 100 includes guide 120, which includes a grid of channels for each fiber optic sensor to maintain a respective position. System 100 also includes a light source connection to each fiber optic sensor to provide light for sensing, and a light sensor to collect the data (e.g., to convert a received light signal to an electrical signal). The plurality of fiber optic sensors allow data collection of force measurements (e.g., as applied to outer layer 101 by a hand or fingers thereof). Optical measurements of light attenuated by the fiber optic elements may be sensed using any suitable approach. For example, in some embodiments, a force applied to a fiber may change an optical property of the fiber such that the light intensity transmitted through the fiber is changed. Changes in the light intensity due to force may occur in a variety of modalities, including fiber deformation or light coupling between fibers, for example. In some embodiments, for example, the light coupling may occur axially through adjacent fiber ends (e.g., from one end of a fiber to the opposite end, as attenuated along the length of the fiber). In a further example, the light coupling may occur when the outer surfaces of two or more adjacent fibers make contact or are otherwise pressed together.

In some embodiments, as illustrated in FIG. 1, system 100 may include an elastomer sensor arranged in a baseball. System 100, implemented as a baseball, may provide players with near real-time pressure information (e.g., in the form of a heat map) showing where the fingers are located on the equipment, how much force is being exerted, and how these factors change over time. System 100 uses fiber optic elastomer sensors aligned in a predetermined design, such as a grid, that may be optimized for data collection to pinpoint both force and location. For example, as a person presses on the grid (e.g., grips the ball), the force causes the fiber optic sensors underneath the surface to change in light intensity coupled through the fiber depending on the amount of force on the sensor. To illustrate, in combination with knowing the location of the fiber sensors on the grid, this detection allows for mapping of the force and its corresponding location on the grid (e.g., an array). By using a grid of fiber optic sensors, force may be mapped for multiple fingers, throughout the length of each finger. Because system 100 uses fiber optic sensors, relatively high sampling rates may be achieved. For example, sampling rates ranging from 1 Hz to 1 MHz may be achieved, thus allowing system 100 to capture even the fastest movements in sports like throwing a baseball or a javelin. Data may be transmitted wirelessly, for example through Bluetooth or WiFi, eliminating the need for any restrictive wires. For example, system 100 may allow for a seamless transition from use of normal equipment (e.g., without sensors) to the force sensing equipment of the present disclosure.

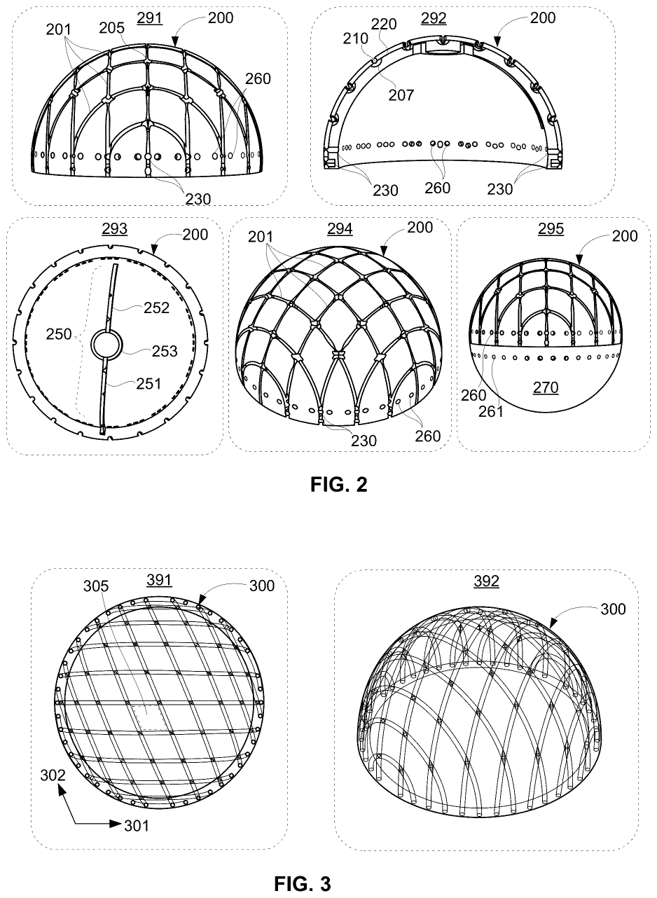

FIG. 2 shows several views of illustrative guide 200 for forming a fiber sensor grid, in accordance with some embodiments of the present disclosure. Panel 291 illustrates a side view, panel 292 illustrates a cross-sectional view taken from the side, panel 293 illustrates a bottom view (e.g., into the hemispherical cavity of guide 200), panel 294 illustrates a perspective view, and panel 295 illustrates a side view of guide 200 and guide element 270. For example, fiber optic sensors may be arranged in channels 201 of guide 200, which may be formed of an elastomeric material. In some embodiments, each fiber optic sensor includes a predetermined lengths (e.g., 5 inches or any other suitable length), based on a respective location within the grid (e.g., each channel may be configured for a fiber of a predetermined length). In some embodiments, the length of each fiber may be, but need not be, unique. In some embodiments, each channels 201 include a suitable recess having a suitable diameter or otherwise dimensions. For example, each of channels 201 may have a uniform diameter or may vary in diameter. In some embodiments, as illustrated, channels 220 have a smaller diameter (e.g., sufficient space for one fiber), while channels 210 have a larger diameter (e.g., to allow space for two fibers to cross at the same location) at the intersections. For example, channels 210 and 220 may have similar dimensions over most of their respective lengths, but at the intersections of channels, channels 220 are recessed further inwards (e.g., radially or nearly radially inward) such that intersecting fibers may cross without protruding outward (e.g., the bottom fiber in the intersection protrudes inwards under the other fiber). Accordingly, each intersection 205 may include an inward recess (e.g., recess 207) to accommodate crossing fibers (e.g., where the thickness of fibers may be double as the fibers are stacked when crossing). In some embodiments, a plurality of fiber optic sensors may be woven or nonwoven and can take on many different spacing options and grid shapes, depending on the arrangement of channels 201.

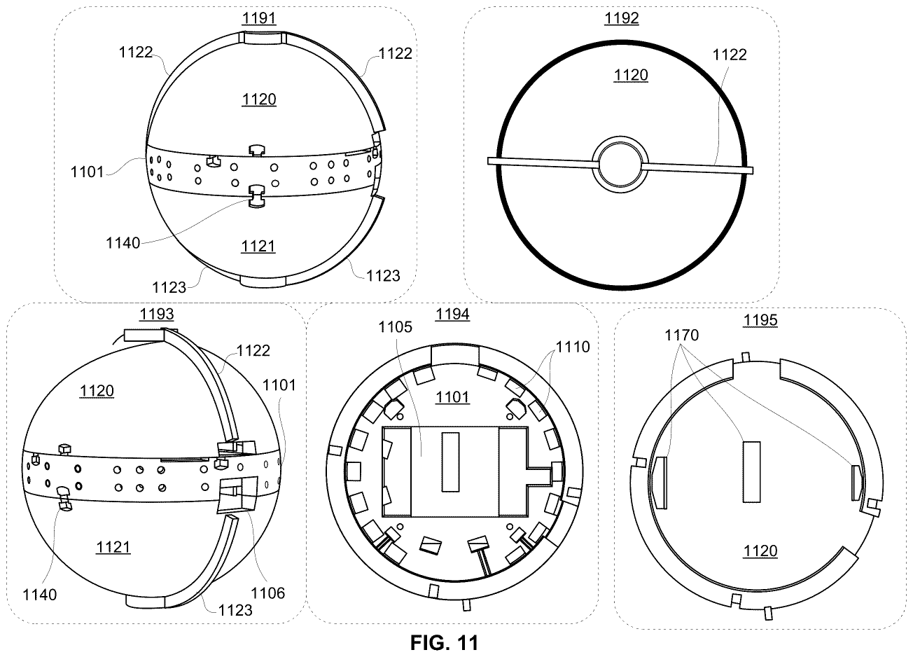

As illustrated, guide 200 includes a plurality of holes 260. For example, guide element 270 (e.g., another elastomeric element that may be similar to guide 200, with or without channels) includes plurality of holes 261 such that guide 200 and guide element 270 may be stitched together by applying stitching to pluralities of holes 260 and 261 to secure guide 200 and guide element 270 together. While illustrated without channels, guide element 270 may be another guide having at least one channel. In an illustrative example, a guide may include two halves (e.g., as illustrated by guide 200 and guide element 270), at least one of which may include channels. In some embodiments, alignment features 250 may be included to align or otherwise provide an interface between guide 200 and an enclosure (as illustrated in FIG. 11). For example, alignment features 250 may include one or more recesses (e.g., holes, slots, channels, or any other suitable recessed feature), one or more bosses (e.g., a pin, a rib, or any other suitable protruding feature), or a combination thereof. As illustrated, alignment features 250 include recessed channels (e.g., cutouts), including ribs 251-252 and ring 253 for interfacing to corresponding ribs and a ring of a support enclosure.

Guide 200, as illustrated, also includes a plurality of channels 230, which include through holes. Plurality of channels 230 extend through the thickness of guide 200 (e.g., radially inward, or otherwise inward), and are configured to accommodate fiber optic sensors. For example, each channel of plurality of channels 230 is sized and arranged to accommodate a respective fiber optic sensor end, which may be inserted through the hole. To illustrate, each fiber optic sensor may have a length, and may extend from a first end to a second end. The first end of the fiber optic sensor may be inserted in a first channel of plurality of channels 230 (e.g., to receive light from a light source), the fiber may then extend along a respective channel of plurality of channels 201, and the second end of the fiber optic sensor may be inserted in a second channel of plurality of channels 230 (e.g., to provide attenuated light to a light sensor). For example, in some embodiments, each channel of plurality of channels 201 may extend between a first channel and second channel of plurality of channels 230. In a further example, the number of plurality of channels 230 may be twice the number of plurality of channels 201. In a further example, a channel of plurality of channels 201 may intersect, and be locally perpendicular or approximately perpendicular to, a first channel and second channel of plurality of channels 230 at the two respective intersections.

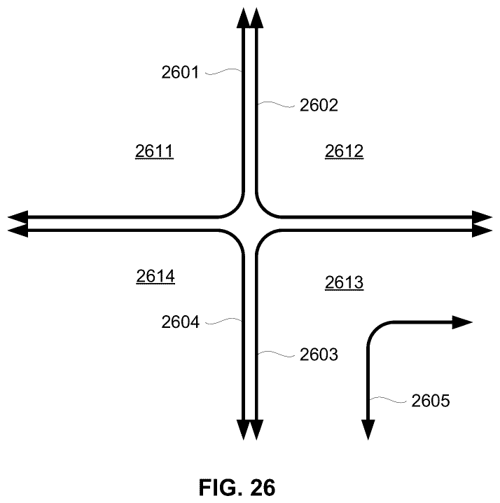

FIGS. 3-6 illustrate guides having differing grid spacing arrangements. It will be understood that the present disclosure may be directed to systems having any suitable number of fiber optic sensors (e.g., one or more), arranged along any suitable paths. For example, the paths (e.g., which may be straight, curved, or combinations of straight and curved sub-lengths) may form regular shapes (the region bounded by fiber sub-lengths) on the hemispherical surface, regular shapes when projected to an area within a projected great circle, irregular shapes, repeating shapes, shapes bounded by equal sub-lengths of fibers, shapes bounded by unequal sub-lengths of fibers, unique shapes, or any combination thereof. Similarly, fiber optic sensors may, but need not intersect. For example, a plurality of fiber optic sensors may be arranged to form a plurality of intersections, where the intersections are equally spaced on the hemispherical surface, equally spaced when projected to an area within a projected great circle, irregularly spaced, arranged in a regular grid, arranged in an irregular grid, arranged at predetermined locations under an out surface of an object, arranged within predetermined regions under an out surface of an object, or any combination thereof. In an illustrative example, a serpentine pattern (e.g., a spiral or other suitable path) may be used. In some embodiments, where fibers are arranged in a grid, the fibers overlap one another and are stacked on top of each other. In some embodiments, fibers need not be stacked, nor intersect, and may all lie in the same plane (e.g., as illustrated in FIG. 26).

FIG. 3 shows a top view (panel 391) and a perspective view (panel 392) of illustrative fiber optic sensor grid 300 with rhombus spacing, in accordance with some embodiments of the present disclosure. Fiber optic sensor grid 300 includes a plurality of fiber optic elements, each having a respective length, arranged with rhombic spacing based on directions 301 and 302, as illustrated. The rhombic spacing is indicated by rhombic projection 305, which is formed by intersecting fibers of fiber optic sensor grid 300 (e.g., as viewed from above or projected to the mid-plane base of the hemisphere).

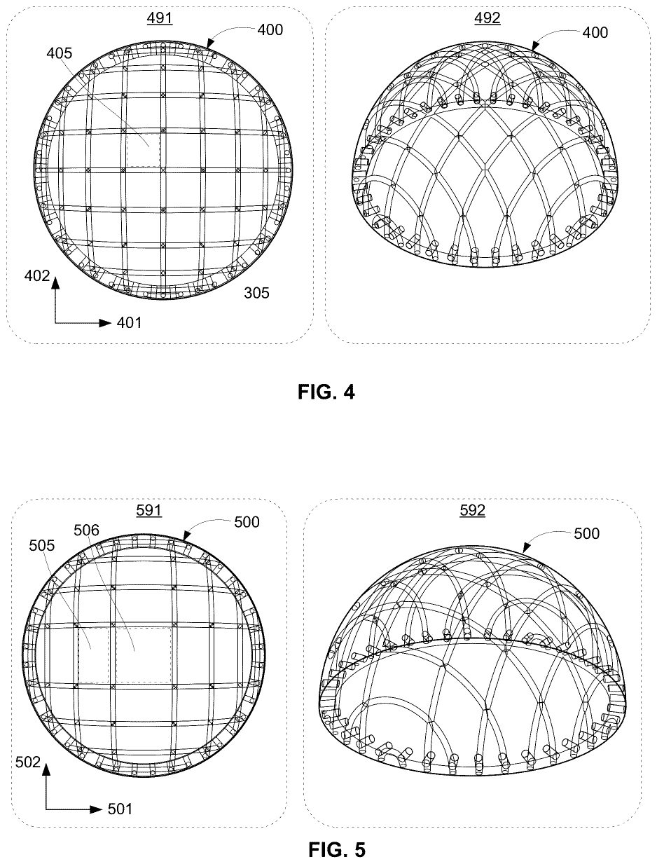

FIG. 4 shows a top view and a perspective view of illustrative fiber optic sensor grid 400 with rectangular spacing, in accordance with some embodiments of the present disclosure. Fiber optic sensor grid 400 includes a plurality of fiber optic elements, each having a respective length, arranged with rectangular spacing based on directions 401 and 402 (e.g., orthogonal directions), as illustrated. The rectangular spacing is indicated by rectangular projection 405, which is formed by intersecting fibers of fiber optic sensor grid 400 (e.g., as viewed from above or projected to the mid-plane base of the hemisphere). For example, rectangular spacing includes square spacing, as well as spacing having a non-unity aspect ratio (e.g., a non-square rectangular).

FIG. 5 shows a top view and a perspective view of illustrative fiber optic sensor grid 500 with an uneven grid spacing, in accordance with some embodiments of the present disclosure. Fiber optic sensor grid 500 includes a plurality of fiber optic elements, each having a respective length, arranged with uneven spacing based on directions 501 and 502, as illustrated. The uneven spacing is indicated by projections 505 and 506, of differing shapes, which are formed by intersecting fibers of fiber optic sensor grid 500 (e.g., as viewed from above or projected to the mid-plane base of the hemisphere). For example, uneven spacing includes rectangular or rhombic spacing, or both, characterized by non-uniform spacing between pairs of adjacent fibers.

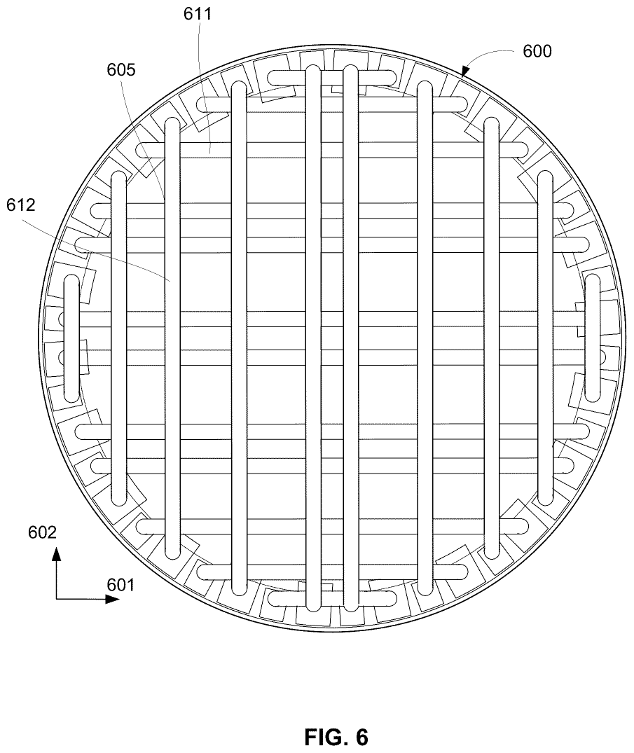

FIG. 6 shows a top view of illustrative fiber optic sensor grid 600 having a differing number of sensor channels in first and second directions (e.g., illustrated by directions 601 and 602) along a grid space, in accordance with some embodiments of the present disclosure. Fiber optic sensor grid 600 includes a plurality of fiber optic elements, each having a respective length, arranged with uneven spacing based on directions 601 and 602, as illustrated. The illustrative spacing of fiber optic sensor grid 600 may form a plurality of intersections 605, which may be arranged in any suitable grid, pattern, irregular arrangement, or combination thereof (e.g., have both regular and irregular regions). For example, a fiber grid may include any suitable number of fibers oriented in each of one more directions. As illustrated in FIG. 6, there are twelve fibers of fibers 611 directed along direction 601 and ten fibers of fibers 612 directed along direction 602 (e.g., forming 72 intersections 605). In a further example, a total of twenty-two fibers, the sum of fibers 611 and 612, may be coupled to twenty-two light sources and twenty-two light detectors.

In an illustrative example, FIGS. 3 and 4 show respective fiber optic sensor grids 300 and 400 each having an 11×11 arrangement, whereas fiber optic sensor grid 600 of FIG. 6 has a 10×12 arrangement (e.g., where the first number is the number of vertically traveling fiber optic sensors and sensor channels and the second is that of the horizontally traveling fiber optic sensor and sensor channels, as illustrated). In a further example, the rhombic spacing of fiber optic sensor grid 300 of FIG. 3 may be modified to result in parallelogram spacing (e.g., wherein a parallelogram shape is projected rather than a rhombus shape). In a further example, a plurality of fiber optic sensors may be arranged such that the grid is triangular (e.g., regions bounded by three fibers).

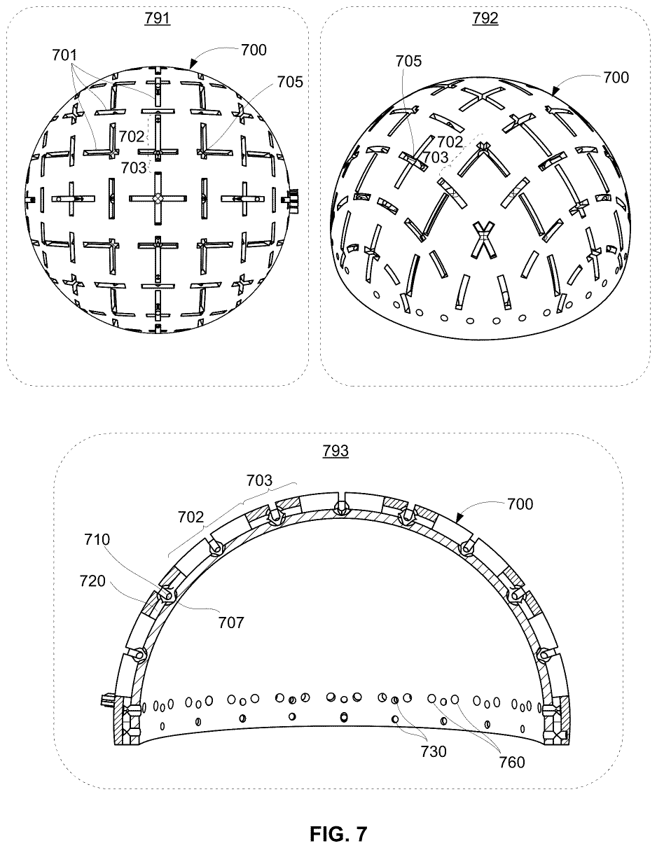

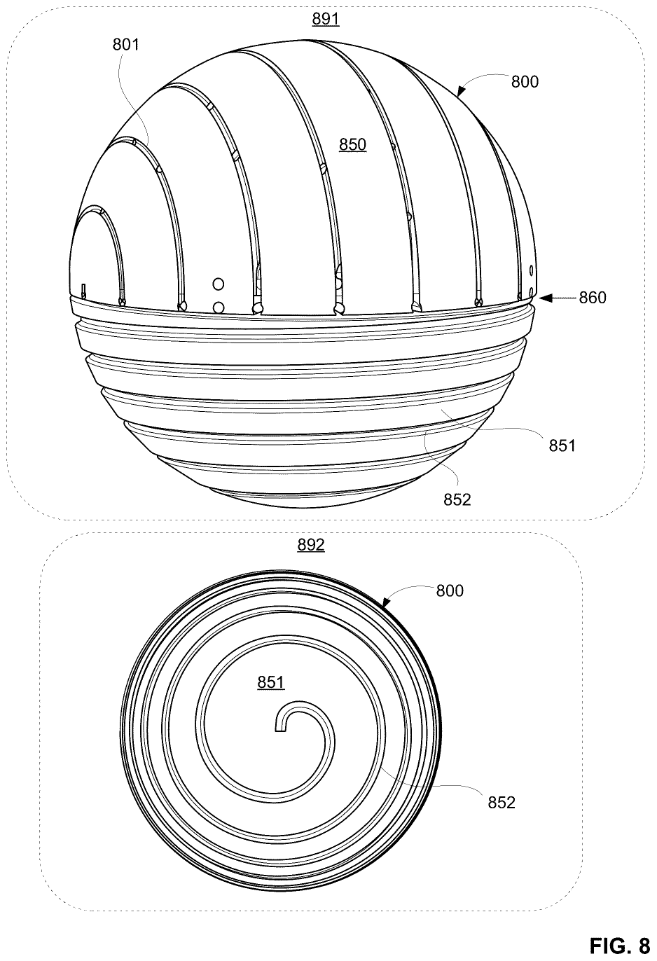

FIG. 7 shows several views of illustrative guide 700 with embedded channels to weave fibers of a fiber grid, in accordance with some embodiments of the present disclosure. A plurality of channels may be arranged at the surface of a surface (e.g., as illustrated by guide 200 of FIG. 2), embedded deeper into the surface. For example, as illustrated, some segments of each channel of channels 701 are open (e.g., open segments 702) and some segments are closed (e.g., closed segments 703). Channels, or segments of channels thereof, may be open, closed, arranged to protrude from the surface (e.g., not illustrated in FIG. 7), or a combination thereof. For example, having open and closed segments may allow guide 700 to more closely and tightly secure the fiber optic elements. In some embodiments, as illustrated, channels 701 includes first set of channels 710 that intersect with second set of channels 720, which are oriented in different directions. As illustrated, recesses 707 are included at intersections 705 to accommodate the crossing fibers of sets of channels 710 and 720.

As illustrated by the top view of panel 790, plurality of channels 701 are arranged to form a fiber grid having rectangular spacing. As illustrated by the perspective view in panel 791, guide 700 includes a plurality of holes 760. For example, another elastomeric hemisphere that may be similarly sized as guide 700, with or without channels and include a complementary plurality of holes such that the two hemispheres (e.g., of which guide 700 is one) may be stitched together by applying stitching to pluralities of holes 260.

As illustrated by the cross-sectional view in panel 792, guide 700 includes plurality of channels 730 that extend through the thickness of guide 700 (e.g., radially inward, nearly radially inward, or otherwise inward), and are configured to accommodate fiber optic sensors. For example, each channel of plurality of channels 730 is sized and arranged to accommodate a respective fiber optic sensor end, which may be inserted through the hole. Each fiber optic sensor may have a length, and may extend from a first end to a second end. The first end of the fiber optic sensor may be inserted in a first channel of plurality of channels 730 (e.g., to receive light from a light source), the fiber may then extend along a respective channel of plurality of channels 701, and the second end of the fiber optic sensor may be inserted in a second channel of plurality of channels 730 (e.g., to provide attenuated light to a light sensor). For example, in some embodiments, each channel of plurality of channels 701 may extend between a first channel and second channel of plurality of channels 730. In a further example, the number of plurality of channels 730 may be twice the number of plurality of channels 701. In a further example, a channel of plurality of channels 701 may intersect, and be locally perpendicular or approximately perpendicular to, a first channel and second channel of plurality of channels 730 at the two respective intersections.

FIG. 8 shows illustrative guide 800 for forming grid arrangements on both hemispheres of a ball, in accordance with some embodiments of the present disclosure. Panel 891 illustrates a side view, while panel 892 illustrates a bottom view. Guide 800 includes hemispheres 850 and 851, which are joined at interface 860 (e.g., nominally corresponding to a disk bounded by a great circle of the nominal spherical shape of guide 800. For example, hemispheres 850 and 851 have similar outer nominal dimensions. As illustrated, hemisphere 850 includes plurality of channels 801 configured to be populated with fiber optic sensors in a grid, and hemisphere 851 includes single channel 852 configured to receive a single fiber. In some embodiments, having two hemispheres, both hemispheres may be populated with one or more channels configured to receive fibers in predetermined configurations. To illustrate, fibers may be arranged in any suitable configuration, covering any suitable area, to provide force sensing where force is likely to be applied (e.g., a sphere as illustrated in FIG. 8, where a user is likely to grip), for example. For example, a guide may include channels configured to arrange sensors to sense force over a hemisphere, arrange sensors in several discrete areas that combined cover more or less than a hemisphere, or both.

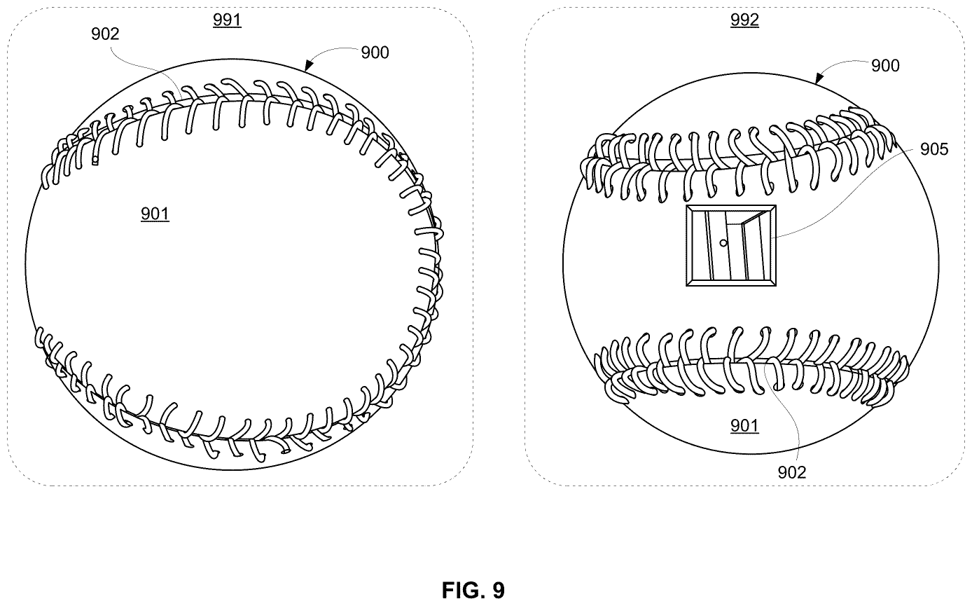

FIG. 9 shows an illustrative assembled force sensing baseball (e.g., baseball 900), in accordance with some embodiments of the present disclosure. Panel 991 illustrates a first view, and panel 992 illustrates a second view from the opposite side as panel 991. As illustrated, baseball 900 includes outer surface 901, to which a user may apply a force. Baseball 900 includes a plurality of fiber optic sensors arranged on top of a support enclosure, with the fiber ends arranged into channels (e.g., such as plurality of channels 230 of FIG. 2) leading to optoelectronics (e.g., of processing circuitry 160 of FIG. 1, or otherwise a PCB). For example, hemispherical guides are stitched using holes (e.g., plurality of holes 260 of FIG. 2), then the sensors in the channels are covered by leather and the leather is stitched close (e.g., in a pattern characteristic of a baseball where the sensing system is installed in a baseball). Outer surface 901 includes stitched leather and seams 902 function to tightly hold everything together and mimic a “real” (e.g., a ball without a sensor system) baseball, as illustrated in FIG. 9. The guide holds the fiber optic sensors in place and achieves a similar stiffness as compared to a “real” baseball, while also allowing the fiber optic sensors to deform under pressure (e.g., to allow force sensing).

Because baseball 900 is instrumented with fiber optic sensors beneath outer surface 901, the spatial and temporal field of applied force may be sensed and recorded for analysis. In some embodiments, systems of the present disclosure may include a port, such as port 905, configured to transfer power, information, or both between the force sensing system (e.g., baseball 900) and external components. For example, one or more batteries of baseball 900 may be charged by connecting a suitable charging cable and connector to port 905. In a further example, a cable and connector may be coupled to port 905, where the cable is configured to provide power transmission and data transmission (e.g., such as a universal serial bus (USB) port or any other suitable type of port). In a further example, a communications cable and connector may be coupled to port 905, and computer instructions may be uploaded to processing circuitry of baseball 900. In a further example, a communications cable and connector may be coupled to port 905, and recorded data (e.g., stored in memory of baseball 900) may be downloaded from processing circuitry of baseball 900 to an external system (e.g., for processing force data). In a further example, power, information, or both may be exchanged between the sensing system (e.g., baseball 900) and an external system by a wireless power interface, a wireless communication interface, or both.

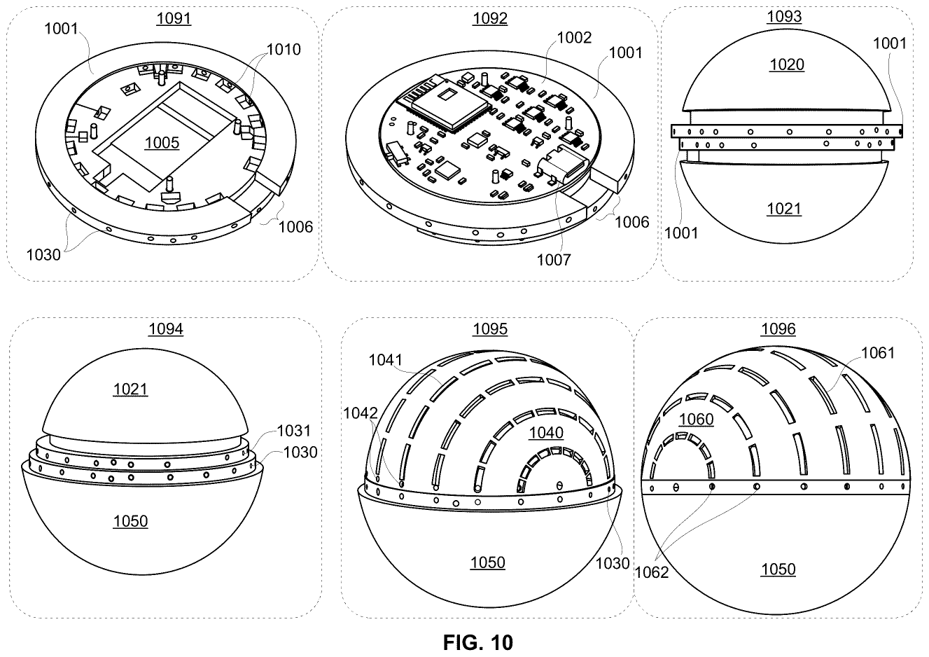

FIG. 10 shows an interior of an illustrative ball having one hemisphere of sensing capabilities with two layers of a fiber sensor grid, in accordance with some embodiments of the present disclosure. As illustrated, structure 1001 is configured to receive PCB 1002, and enclosures 1020 and 1021 (e.g., opposing spherical caps) are configured to cover PCB 1002, and interface to structure 1001. Structure 1001 includes opening 1005 configured to accommodate portions of a PCB (e.g., a processor, battery, circuit components, memory hardware, any other suitable components, or any combination thereof). Structure 1001 also includes plurality of channels 1030 and 1031, through which fiber optic elements may be routed (e.g., from a fiber optic sensor grid to the processing circuitry of PCB 1002). Structure 1001 also includes recesses 1010 (e.g., recessed into a surface of structure 1001) configured to allow PCB 1002 to sit flush with the surface and such that optoelectronics (e.g., light detectors configured to detect modulated light from each fiber optic sensor) each have their own recess that separates them from each other. For example, the number of recesses 1010 may be equal to or greater than the number of light detectors. As illustrated, structure 1001 includes opening 1006 configured to allow connections to PCB 1002 (e.g., USB connector 1007 as illustrated) from external components (e.g., acting as a port such as port 905 of FIG. 9).

Guide element 1050, formed from an elastomeric material and without channels for fiber optic sensors, is installed over enclosure 1020, to form a hemisphere. First guide 1040 is installed over enclosure 1021, and includes a first plurality of channels 1041 (e.g., oriented in a first direction, as illustrated). Channels 1042 (e.g., through holes) of first guide 1040 may be aligned with plurality of channels 1031 such that fibers may be routed outward and then along channels 1041. Second guide 1060 is installed over first guide 1040, and includes a second plurality of channels 1061 (e.g., oriented in a second direction, as illustrated). For example, first and second pluralities of channels 1041 and 1061 are configured to form a fiber optic sensor grid. Channels 1062 (e.g., through holes) of second guide 1060 may be aligned with plurality of channels 1030 such that fibers may be routed outward and then along channels 1061. As illustrated, second guide 1060 includes outer dimensions to match guide element 1050, such that together they nominally form a sphere. It will be understood that although only one half of the ball of FIG. 10 includes fiber optic elements, another guide may be installed and may include one or more channels and fiber optic elements. For example, in some embodiments, guide element 1050 may be omitted, and additional guides such as first and second guides 1040 and 1060 may be included such that the fiber optic sensor grid extends over the entire sphere. In a further example, a fiber optic grid may be uni-layer (e.g., as illustrated in FIGS. 2-7) or multi-layer (e.g., as illustrated in FIG. 10). First and second guides 1040 and 1060 form a bi-layer grid, with the inner fiber grid (e.g., defined by first guide 1040) having a predetermined number of channels (e.g., such as nine channels) having a predetermined layer thickness, and with the outer fiber grid (e.g., defined by second guide 1060) having a predetermined number of channels (e.g., such as nine channels) with a predetermined layer thickness. The outer grid sits on top of the inner, as illustrated.

FIG. 11 shows an illustrative interior support enclosure to fiber sensor grid, in accordance with some embodiments of the present disclosure. As illustrated, structure 1101 interfaces to enclosures 1120 and 1121 (e.g., opposing spherical caps). For example, structure 1101 may be configured to mount a PCB (e.g., similar to structure 1001 of FIG. 10), and enclosures 1120 and 1121 are configured to cover the PCB. Structure 1101 includes recess 1105 (e.g., which may include an opening a volume) configured to accommodate portions of a PCB (e.g., a processor, battery, circuit components, memory hardware, any other suitable components, or any combination thereof), plurality of channels 1130, through which fiber optic elements may be routed, and recesses 1110 configured to accommodate optoelectronics. To illustrate, one or more guides may be installed over enclosures 1120 and 1121 and may include channels or other suitable features to define a fiber optic sensor grid. The support enclosure formed by enclosures 1120 and 1121 is configured to house both PCBs and batteries (e.g., using recess 1105). For example, a combination of electrical components and optoelectronics may be arranged on a PCB in a suitable manner to accomplish light sensing. Using the PCB, information may be recorded at suitable sample rates (e.g., in a predetermined range such as 1 Hz-1 MHz). The PCB may include a predetermined quantity of optoelectronic pairs (e.g., a light source and a light detector) and sensing channels (e.g., fiber optic elements) such as 22 pairs and 22 sensing channels, for example. In some embodiments, as illustrated, structure 1101 and enclosure 1121 may form opening 1106, which may accommodate a port (e.g., for a USB connection, or any other suitable connection).

The support enclosure formed by enclosures 1120 and 1121 is configured to support the grid holding the required shape and provide resistance to deformation. The support enclosure also acts as a lid to protect the PCB and keep it in place, for example. In some embodiment, as illustrated, enclosure 1120 includes features 1170 (e.g., pegs) to help hold the PCB in position. For example, enclosures 1120 and 1121 may include injected foam (e.g., of varying densities) that may be used to adjust weight and stiffness (e.g., to match that of a “real baseball,” alter the weight distribution and aerodynamics of the ball, or both). The support enclosure acts as a barrier around the PCB better protecting it from the forces applied to the object (e.g., during throwing), while also including channels 1130 through which optical fibers are placed to interface to the optoelectronics of the PCB. For example, channels 1130 allow for better alignment of the fibers to the optoelectronics and helps to hold the fibers and the grid in place. Alignment rails 1122 and 1123, of respective enclosures 1120 and 1121, are configured to interface (e.g., include mating features that engage with complementing features of a guide) with corresponding recesses of one or more guides (e.g., as illustrated by alignment features 250 in FIG. 2). For example, alignment rails 1122 and 1123 include curved ribs and circular sections, which interface to mating features of a guide. In some embodiment, I-shaped bars are configured to interface to recesses 1140 (e.g., formed by recesses in enclosures 1120 and 1121 and structure 1101) to attach enclosures 1120 and 1121 to structure 1101. For example, the I-shaped bars may enable alignment of the components and ensure alignment is maintained while the system is used.

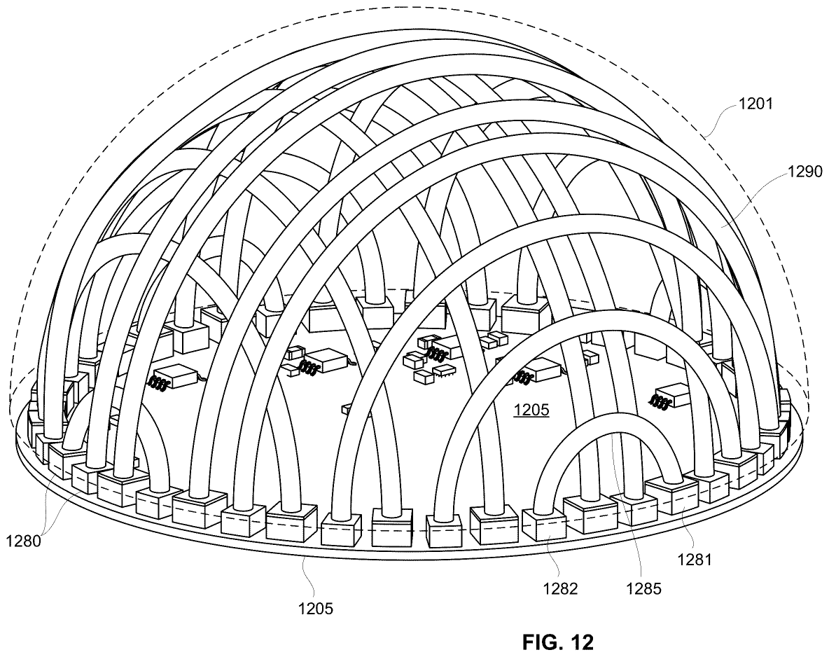

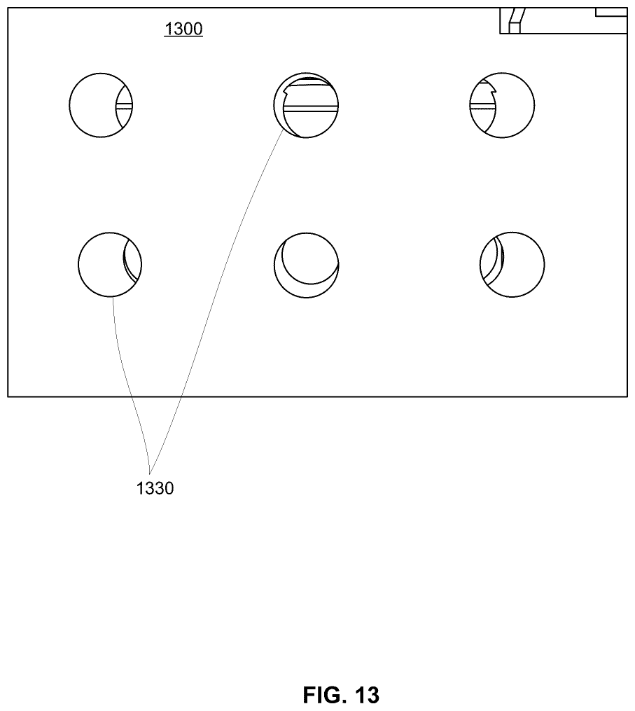

FIG. 12 shows a perspective view of an illustrative fiber sensing grid interfacing optoelectronics, in accordance with some embodiments of the present disclosure. For example, system 1200 may correspond to one half of a baseball having a sensor system (e.g., with outer layer 1201 and any guides and support enclosures removed). In some embodiments, the optoelectronics are oriented top-down, with direct mating from each fiber optic sensor to an optoelectronic. For example, each optoelectronics can be placed in a suitable orientation, such as a concentric ring, to make routing easier for various array designs. As illustrated, system 1200 includes plurality of fiber optic sensors 1290 arranged in a grid, each fiber optic element extending along a curved path from a first optoelectronic (e.g., a light source) to a second optoelectronic (e.g., a light detector), of plurality of optoelectronics 1280. To illustrate, fiber 1285 extends between light source 1281 and light detector 1282.

Plurality of optoelectronics 1280 are mounted as part of PCB 1205, oriented in a direction roughly normal to the plane of PCB 1205. In some embodiments, PCB 1205 includes a microcontroller unit (MCU), an accelerometer, a gyroscope, any other suitable electrical components, or any combination thereof, that may be used to collect additional data relevant to the equipment. In some embodiments, PCB 1205 includes memory configured to store data that may be transmitted wirelessly in real-time or via wires or wirelessly at a later time. In some embodiments, PCB 1205 may be charged using either or both wired or wireless charging.

FIG. 13 shows a side view of illustrative sensor channels interfacing to optoelectronics at a side, in accordance with some embodiments of the present disclosure. A portion of structure 1300 is illustrated from the side in FIG. 13 (e.g., radially inward from the edge of structure 1300 (e.g., along a great circle of the sphere), showing channels 1330 that are directed outward (e.g., radially, or nearly radially, outward). For example, channels 1330 are directed outward such that fibers may need to bend inwards at their ends, rather than terminating at optoelectronics normal to the PCB (e.g., as illustrated in FIG. 12). Referencing FIG. 13, a PCB may include a plurality of optoelectronics oriented outward (e.g., rather than normal to the PCB, as illustrated in FIG. 12). A structure may be configured to mount a PCB having optoelectronics oriented in any suitable direction, and include channels oriented in any suitable direction to accommodate fibers (e.g., to interface to the optoelectronics).

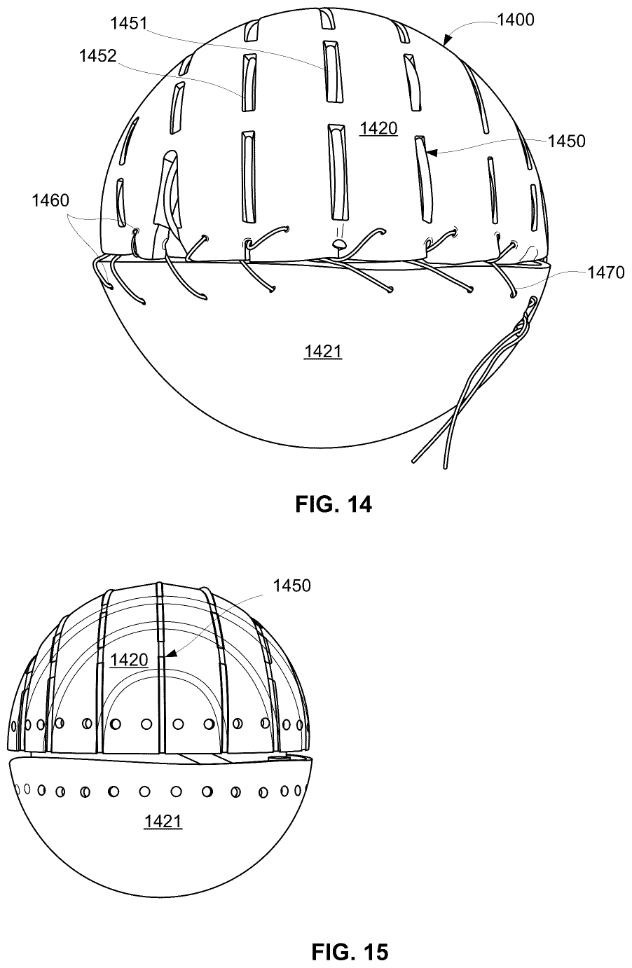

FIG. 14 shows illustrative partially assembled spherical grid populated with fiber sensors, in accordance with some embodiments of the present disclosure. As illustrated, guide 1420 with channels and guide element 1421 without channels are stitched together (e.g., using stitching 1470 through holes 1460) to form sphere 1400 having an elastomeric outer layer (e.g., upon which leather and outer stitching may be applied). Guide 1420 includes a plurality of channels, which accommodate plurality of fiber optic elements 1450. For example, fibers 1451 and 1452 are adjacent and extend over guide 1420 in a first direction. Each fiber of plurality of fiber optic elements 1450 may interface to an optoelectronic device at each end (e.g., a light source at a first end and a light detector at a second end). FIG. 15 shows a side view of the illustrative assembled spherical grid of FIG. 14 with one hemisphere populated (e.g., using guide 1420). For example, light may be transmitted through each fiber of plurality of fiber optic elements 1450.

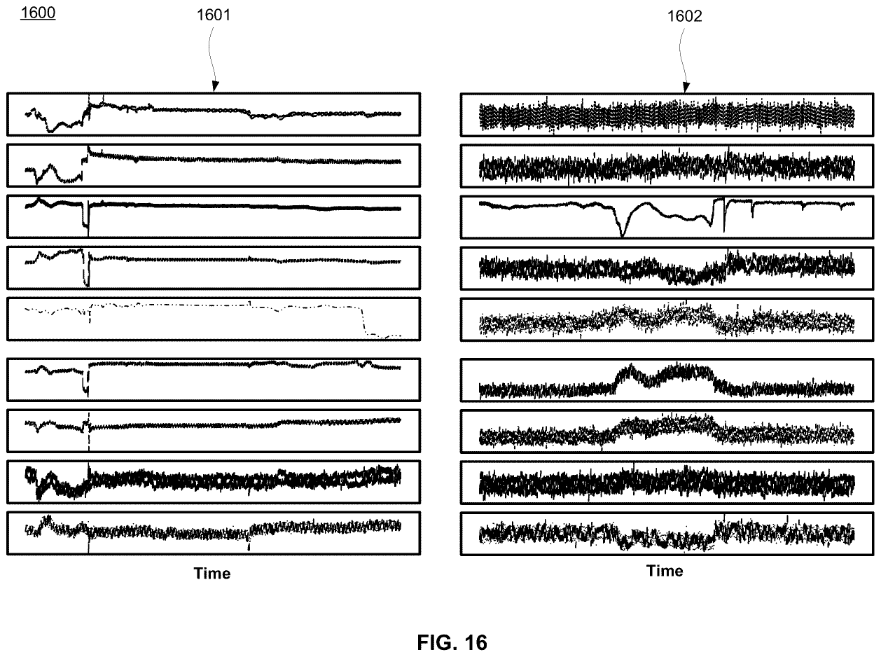

FIG. 16 shows plots of illustrative data output from processing circuitry during a throw of the ball, in accordance with some embodiments of the present disclosure. For each plot, the abscissa is time, and the ordinate is the respective electrical signal (e.g., an analog voltage, as read by an analog to digital converter). Set 1601 of plots corresponds to a first nine signals, while set 1602 corresponds to another nine signals. Each plot of FIG. 16 corresponds to temporal measurements from a light detector coupled to a fiber optic element. Processing circuitry may record data for any suitable number of light detectors (e.g., data channels), at any suitable sampling rate. For example, the processing circuitry may be configured to execute computer instructions, such as a software application that controls the sampling rate, data collection, and data storage. As force is exerted on the ball, the intensity of the light incident on the light sensors changes as seen for a throw in FIG. 16.

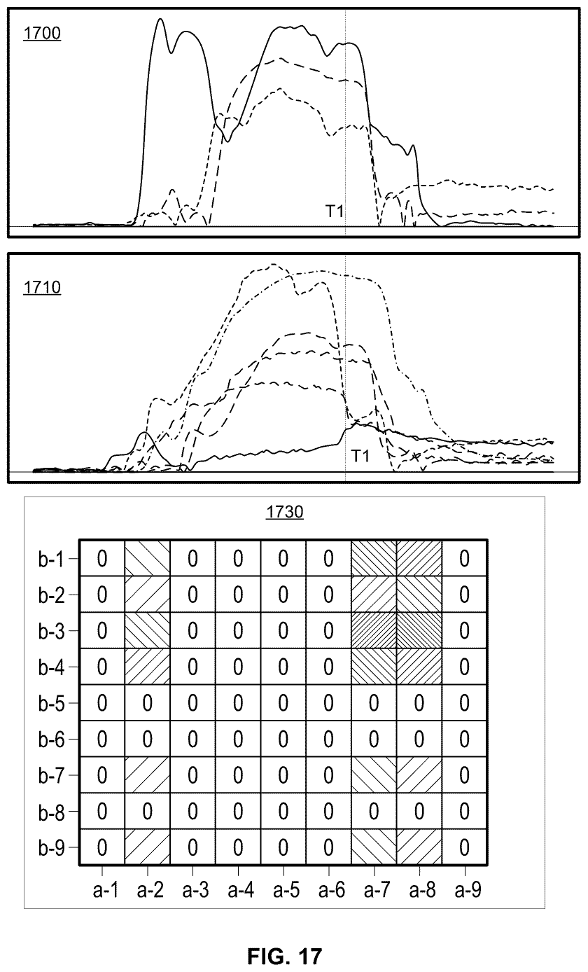

FIG. 17 shows plots of illustrative fiber data and an illustrative corresponding heat map, in accordance with some embodiments of the present disclosure. For example, the processing circuitry may implement a software application that takes changes in light intensity (e.g., such as those show in FIG. 16) and outputs force, as illustrated in FIG. 17. Plots 1700 and 1710 illustrate light intensities for a 9×9 grid, with plot 1700 corresponding to signals from fibers oriented in a first direction, and plot 1710 corresponding to signals from fibers oriented in a second direction. The processing equipment may determine forces based on the signals of plots 1700 and 1710, and may also, for example, generate a two-dimensional or three-dimensional heat map, as illustrated by heat map 1730, to provide another representation of the spatial and temporal field of force on the outer surface. Heat map 1730 FIG. 17 is representative of the force values of FIG. 17, taken at time T1 (e.g., with “a” and “b” indexing fiber optics oriented in the two respective directions). Values of zero in heat map 1730 represent no alteration in fiberoptic signal transmission, and areas of increasing shading density (e.g., darker) represent increased fiber deformation from, in this case, finger pressure. In some embodiments, a decreased light propagation from deformation may be caused by ballistic impact, foot falls, or any other suitable force applied to a fiber or surface having fibers.

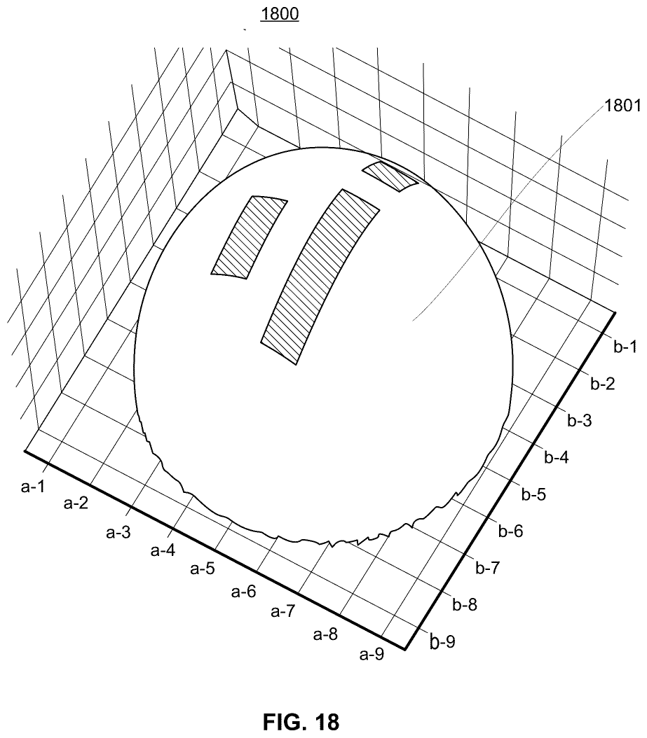

FIG. 18 shows illustrative force heat map 1800 projected on a single hemisphere, in accordance with some embodiments of the present disclosure. As illustrated in FIG. 18, regions of relatively more force are shown with hatching across hemispherical surface 1801, which corresponds to the outer surface of the system under test (e.g., the instrumented baseball). For example, force heat map 1800 may correspond to half of a ball (e.g., a hemisphere), showing finger pressure being applied to a ball in three locations. For example, as illustrated, the left most location is a finger and the right most locations are from the same finger in two locations, indicating a particular pitch type. In an illustrative example, a projectile (e.g., a bullet or other object) may be located or otherwise localized by determining a force profile from impact (e.g., to a target, or if applied to a garment, a person for wound detection and triage). In some embodiments, a heat map, such as force heat map 1800, may be used to reconstruct shapes or pressure interactions (e.g., in a Virtual or Augmented Reality environment).

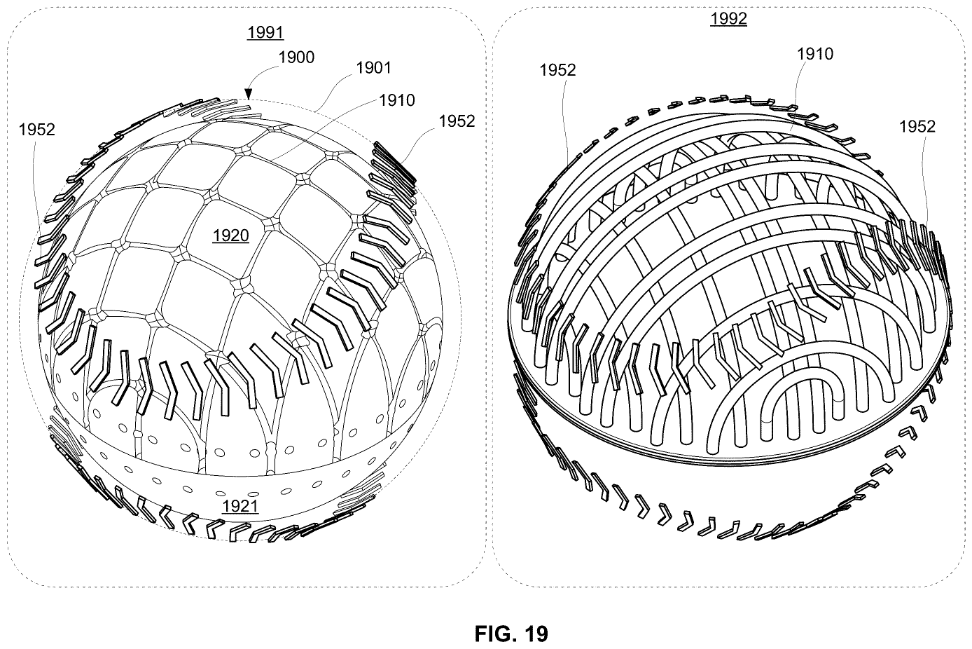

FIG. 19 shows an illustrative example of baseball 1900 with the sensing hemisphere located for pitch grip pressure sensing, in accordance with some embodiments of the present disclosure. Panel 1991 illustrates baseball 1900 with laces 1952 in place, but with leather portions forming outer layer 1901 hidden (e.g., indicated by a dashed line). Panel 1992 illustrates baseball 1900 with laces 1952 in place, but with leather portions forming outer layer 1901 hidden (e.g., indicated by a dashed line) as well as the guide to show the fibers more clearly. As illustrated in FIG. 19, sensing hemisphere 1920 is arranged in a predetermined configuration, under a partial lobe of the baseball along laces 1952 (e.g., stitching together leather portions) that allows the processing equipment to collect pitch grip data. Plurality of fiber optic sensors 1910 are arranged to form a grid in sensing hemisphere 1920. Hemisphere 1921, which forms the other half of the sphere, does not include fiber optic sensors, as illustrated.

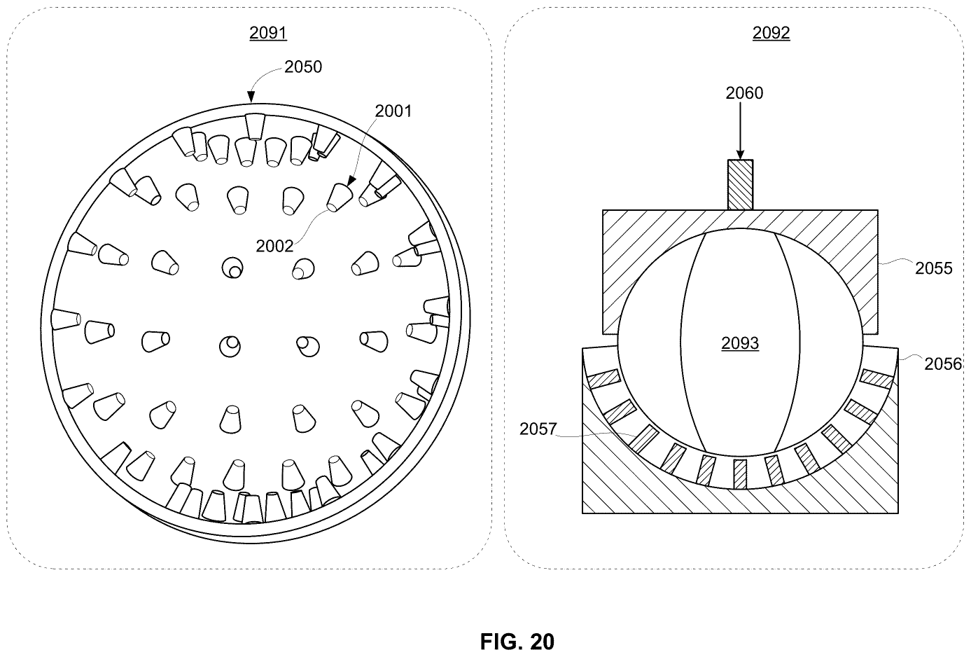

FIG. 20 shows illustrative examples of calibration methods, using spikes to create known strains or applying a known force, in accordance with some embodiments of the present disclosure. As illustrated in panel 2091, calibration tool 2050 includes plurality of protrusions 2001 (e.g., flat-tipped spikes, as illustrated) having an optionally predetermined area at contact end 2002. Calibration tool 2050 may be used to apply a spatial and temporal field of forces to the surface of a system for testing. For example, calibration tool 2050 may be sized to fit around a baseball (e.g., one hemisphere of a baseball) to calibrate light detectors of the baseball to know applied forces. In a further example, calibration of an instrumented system (e.g., such as a baseball) may be performed using any suitable method, including exposing the outer surface of the system (e.g., the ball) to predetermined weights, forces, or strains. For example, this loading may allow the processing equipment to correlate changes in signals to known applied forces at one or more locations on the surface. As illustrated in panel 2092, calibration may include arranging one or more calibration tools 2055 and 2056 (e.g., having protrusions 2057), which are configured to apply a predetermined force (e.g., force 2060) to outer surface 2093 of the system under test, which may experience a spatial field of force corresponding to force 2060.

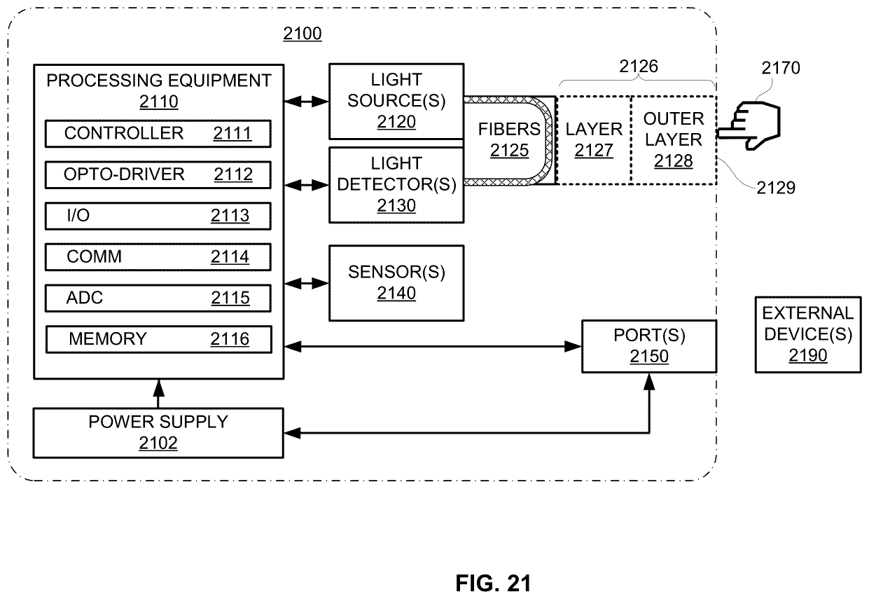

FIG. 21 is a block diagram of illustrative system 2100 for detecting applied force, in accordance with some embodiments of the present disclosure. As illustrated, system 2100 includes processing equipment 2110, power supply 2102, one or more light sources 2120 (also referred to as light source(s) 2120), one or more fiber optics (referred to herein as fibers 2125), one or more light detectors 2130 (also referred to as light detector(s) 2120), layer 2127, outer layer 2128, one or more sensors 2140 (also referred to as sensor(s) 2140), and one or more ports 2150 (also referred to as port(s) 2150).

Processing equipment 2110 (also referred to herein as processing circuitry), as illustrated, includes controller 2111, opto-driver 2112, input/output interface 2113 (I/O interface 2113), communications interface 2114 (COMM 2114), analog-to-digital converter 2115 (ADC 2115), memory 2116, and any other suitable components (e.g., communications buses, circuitry, devices), or any combination thereof. Controller 2111 may be implemented by one or more MCUs, processors, communications buses, FPGAs, embedded systems, any other suitable device, any other suitable combination of hardware and software, or any combination thereof. For example, processing equipment 2110 may be the same as, include, or be included as part of, processing circuitry 160 of FIG. 1, PCB 1002 of FIG. 10, or PCB 1205 of FIG. 12.

In some embodiments, opto-driver 2112 may include a processor, circuit, or combination thereof configured to generate control signals for light source(s) 2120. For example, in some embodiments, light source(s) 2120 may include LEDs, and opto-driver 2112 is configured to generate and transmit an electrical signal having predetermined properties (e.g., as determined by controller 2111) to each light source.

In some embodiments, I/O interface 2113 may include one or more analog terminals, one or more digital terminals, one or more relay terminals, or any combination thereof to receive or provide signals. In some embodiments, for example, opto-driver 2112 may be combined with I/O interface 2113, or otherwise be a part of I/O interface 2113, and need not be a separate component (or considered a separate component). For example, terminals of I/O interface 2113 may be configured to provide and/or receive signals from sensor(s) 2140, light source(s) 2120, light detector(s) 2130, terminals of port(s) 2150, power supply 2102, or a combination thereof.

COMM 2114 may include a PCB, circuitry, any other suitable components for communicating with other units, devices, or components, or any combination thereof. In some embodiments, COMM 2114 may be implemented as part of controller 2111 and need not be included as a separate component. In some embodiments, COMM 2114 is included, as illustrated, and may be configured to interface to a suitable communications network such as using ethernet via an RJ45 connector of port(s) 2150, a serial bus using a USB connector, or any other suitable communications protocol and interface.

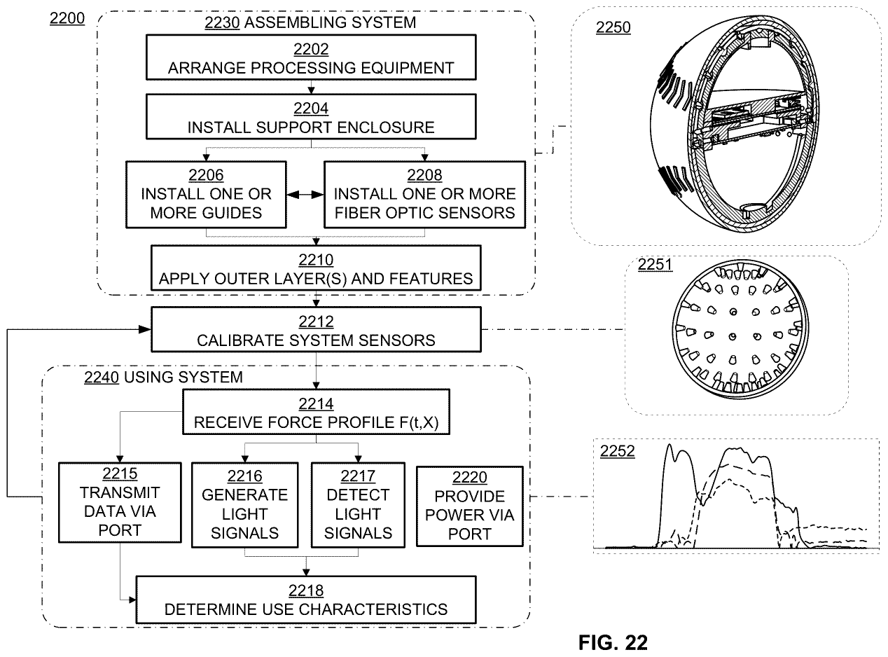

Memory 2116 may include any suitable type of memory such as solid state, a hard disk, removable media, or a combination thereof, for example. In some embodiments, for example, memory 2116 includes non-transitory computer readable media configured to store computer instructions to perform at least some steps of processes 2200 described in the context of FIG. 22.

Power supply 2102 is configured to provide power to processing equipment 2110, light source(s) 2120, light detector(s) 2130, and sensor(s) 2140, and optionally receive power (e.g., during charging) from an external device of external device(s) 2190 via port(s) 2150. For example, power supply 2102 may include one or more batteries, arranged in series, parallel, or a combination thereof, and include a positive and a negative terminal. In a further example, processing equipment 2110 may implemented as a PCB having a socket with terminals for installing one or more batteries. In a further example, processing equipment 2110 may be coupled to a separately mounted socket having terminals for installing one or more batteries. In some embodiments, processing equipment 2110, power supply 2102, or both include a power conditioning circuit configured to manage a voltage, a current, an impedance, or a combination thereof during power usage, charging, or both.

Light source(s) 2120 each may include an optoelectronic device (or “an optoelectronic”) configured to take as input an electrical signal and output a light signal (e.g., also referred to as an optical signal or a photonic signal). Each light source of light source(s) 2120 may generate a respective light signal, comprising electromagnetic radiation, having any suitable intensity (e.g., directed over any suitable spatial field), modulation (e.g., frequency, amplitude, phase) or otherwise temporal character. For example, each light source may include a light emitting diode (i.e., a photo diode, and edge-emitting LED), laser (e.g., a laser diode), any other suitable device for emitting a light signal, any suitable variation thereof, or any combination thereof. For example, each light source may generate a light signal having any suitable spectral character (e.g., include any suitable wavelength(s) or ranges of wavelengths), temporal character (e.g., modulated, shuttered, or otherwise varied in time), spatial character (e.g., beam width, focus), or combination thereof. For example, light source(s) 2120 may correspond to a set of devices of plurality of optoelectronics 1280 of FIG. 12. In some embodiments, flashes of bright light (e.g., from an explosion) may exceed an absorptivity threshold of a coating material, which may function as a high-speed trigger for duty cycle to detect surface pressure and/or force (e.g., blast over-pressure). For example, system 2100 may use the light flash to trigger high-speed sampling using ADC 2115 (e.g., of detected light signals of light detectors 2130).

Fibers 2125 may include one or more fiber optic elements (e.g., a plurality of fiber optic elements), each having a respective length and diameter. Fibers 2125 may be arranged to form a grid or other suitable pattern or otherwise arrangement for sensing force over outer surface 2129 of outer layer 2128. In some embodiments, for example, fibers 2125 may be embedded or otherwise interfaced to an elastomeric guide (e.g.,. For example, the guide may also form layer 2127 between a support enclosure and an inner surface of outer layer 2128. In a further example layer 2127 may be arranged between fibers 2125 and outer layer 2128. In a still further example, layer 2127 may include fibers 2125 dispersed within (e.g., arranged in channels of a guide to form a grid) and be arranged between a support enclosure and outer layer 2128. Each fiber of fibers 2125 may follow a path (e.g., along a portion of a hemisphere), from a light source of light source(s) 2120 to a light detector of light detector(s) 2130. For example, a light source may generate a light signal, which is attenuated as it is transmitted through a fiber, and then the attenuated light signal reaches a light detector. In a further example, a plurality of light sources may generate respective light signals, which are attenuated as they are transmitted through a plurality of fiber, and then the plurality of attenuated light signals reach a plurality of a light detectors. To illustrate, light provided by a first light source to a first fiber may reach more than one light detector (e.g., via coupling among fibers) including a first light detector at an end of the first fiber and other light detectors at respective ends of other fibers that may receive light via coupling from the first fiber. In an illustrative example, fibers 2125 may be the same as plurality of fiber optic sensors 1290 of FIG. 12. In a further, fibers 2125 may be arranged in any suitable manner, including the illustrative grids illustrated in FIGS. 3-7 using any suitable guides. In some embodiments, layers 2126 may be omitted. For example, fibers 2125 may be arranged on an outer surface such that force is directly applied to fibers 2125 without intervening layers (e.g., layers 2126). In a further example, either or both of layer 2127 and outer layer 2128 may include a coating on one or more fibers of fiber 2125 (e.g., with or without forming a planar layer or a continuous layer over an outer surface).

Light detector(s) 2130 each may include an optoelectronic device (or “an optoelectronic”) configured to take as input a light signal (e.g., also referred to as an optical signal or a photonic signal) and output or modulate an electrical signal. Each of light detector(s) 2130 may include a photo diode, photo transistor, photo resistor, CMOS imager, any other suitable detector, or combination thereof. In some embodiments, a light detector may include an active area or region for which incident light is converted to the electrical signal or modulation of a signal. In some embodiments, each light detector is soldered or otherwise affixed to a PCB, and arranged to receive a light signal as attenuated by fiber optic senses. For example, light detector(s) 2130 may correspond to a set of devices of plurality of optoelectronics 1280 of FIG. 12.

In an illustrative example, light sources 2120 may provide a light signal to each fiber of fibers 2125 (e.g., a plurality of light signals, one for each of a plurality of fibers). Each of fibers 2125 may be configured to trap light via internal reflection at a critical angle defined by an index of refraction of the inner core and cladding material (e.g., air, silicone, PTFE, or other suitable cladding). For example, when the fiber shape is changed, from pressing for example, the local curvature changes and light rays previously trapped within the fiber can escape, reducing the light intensity measured by the optoelectronics (e.g., light detectors 2130 detect a signal having lesser intensity).

Sensor(s) 2140 each may include an accelerometer, gyroscope, thermal sensor (e.g., a thermocouple, thermistor, or other suitable temperature sensor), any other suitable electrical components, or any combination thereof. Sensor(s) 2140 are in addition to fibers 2125 or light detector(s) 2130, and may include other types of sensors that may integrated into a PCB (e.g., in processing equipment 2110), electronically coupled to a PCB, or otherwise in communication with a PCB.

External device(s) 2190 may include any suitable processing equipment external to system 2100 such as, for example, a server, a computer, a mobile device, a MCU, any other suitable computing device, or any combination thereof. External device(s) 2190 may implement any suitable software, application, application programming interface (API) that may be hosted by another device, database, data storage format,

In an illustrative example, controller 2111 may generate and transmit a control signal to opto-driver 2112, which may generate and transmit an electrical signal to light source(s) 2120 based on the control signal. Light source(s) 2120 may then generate respective light signals. Fibers 2125 may transmit the respective light signals to light detector(s) 2130, which may generate output electrical signals based on the detected light. The output electrical signals may be received at ADC 2115 (e.g., at analog channels thereof), and ADC 2115 may sample the output electrical signals and store the sampled values in memory 2116. As force 2170 is applied (e.g., by a user's hand) to outer surface 2129 of outer layer 2128, the force may be transmitted through layer 2127 or a portion thereof to fibers 2125. Fibers 2125 may attenuate at least one of the plurality of light signals based on the transmitted force. The attenuation is detected by light detector(s) 2130 and is included in data generated by ADC 2115 and stored in memory 2116. By processing the data, the applied force (e.g., force 2170) may be measured, and a spatial and temporal field of force values may be determined.

In an illustrative example, as data is collected and stored in memory 2116, the data may processed by system 2100 or may transmitted to external device(s) 2190 for processing (e.g., post-processing is transmitted as a batch after a measurement event). In some embodiments, controller 2111 may process data from memory 2116 in real-time to extract force values indexed by position, time, or both. In some embodiments, the data may be transmitted by COMM 2114 to port(s) 2150 and provided to external device(s) 2190 for processing. For example, data for a measurement (e.g., a pitch or throw, a series of pitches and throws) may be transmitted as a batch to external device(s) 2190, via port(s) 2150) and external device(s) 2190 may determine force values, force mappings, any other suitable usage characteristics, or any combination thereof. For example, in some embodiments, in order to reduce mass and complexity of system 2100, external device(s) may be used to perform computationally complex or expensive (e.g., in power or time demand) tasks after the data has been collected. In a further example, external device(s) 2190 may apply any suitable post-processing to the data including filtering, normalizing, combining (e.g., forming new variables based on measured data), differencing (e.g., to determine derivatives or moments), summing (e.g., to determine integrals or weighted representative values), statistical analysis, machine learning, any other suitable processing, or any combination thereof taking as input the data collected from light detector(s) 2130 and sensor(s) 2140, stored in memory 2116, and transmitted by COMM 2114 via port(s) 2150. In some embodiments, if processing equipment 2110 applies sampling rate that causes data acquisition faster than a wireless data transfer rate of COMM 2114 (e.g., via port 2150), the data may be stored in memory 2116 (e.g., for later transfer, or as a buffer). In some embodiments, processing equipment 2110, or ADC 2115 thereof, uses a trigger configured to measure a rate of change of light, an acceleration measured by one or more of sensors 2140, or a combination thereof, to switch between low and high data rates (e.g., low or high sampling rates). To illustrate, system 2100 may capture respiration measurements at 100 Hz (e.g., when fibers 2125 are integrated in an article of clothing). In a further example, system 2100 may detect an explosion from a high rate of change in light transmitted by a fiber, or based on an accelerometer of sensors 2140, and switch to a 1 MHz sampling rate to capture a shock wave. Accordingly, processing equipment 2110, or ADC 2115 thereof, may operate at any suitable sampling rate of signals from light detectors 2130.

In an illustrative example, port(s) 2150 may include a USB port configured to receive a USB cable and connector to provide data transfer, power transfer, or both, with one or more of external device(s) 2190. In a further example, port(s) 2150 may include a single port similar to port 905 of FIG. 9.

In an illustrative example, each fiber of fibers 2125 may, but need not, include cladding along an outer surface of the fiber. For example, in some embodiments, all of fibers 2125 either include cladding or do not include cladding. In a further example, a subset of fibers 2125 may include cladding (e.g., all fibers oriented in a first direction, such that cladding is arranged at intersections of fibers such that the fibers do not directly contact each other). In some embodiments, if an uncladded fiber touches another uncladded fiber, light may leak from a given fiber into another fiber. The increased intensity from one fiber and decrease from another may allow system 2100 to determine a localization of pressure. In some embodiments, for example, cladded fibers may be arranged in a grid, and a decrease in output intensity from each fiber can be used to localize where a touch occurs, and the magnitude of light change can signal how much pressure is applied. For example, when these fibers are embedded in a soft material (e.g., of layer 2127, outer layer 2128, or both), the receptive field of strain may be large and fibers 2125 do not have to be deformed directly by a force acting where the fibers are located. Rather, a grid of fibers may respond to forces applied even centimeters away from where the fibers are actually located., allowing system 2100 to resolve touch location using a larger grid spacing than the touch resolution achievable. To illustrate, a 1 mm positional accuracy may be achieved by a 1 cm grid spacing of fibers if the fibers are embedded in a relatively soft (e.g., compliant) material, such as that with an elastic modulus ranging between 10 kPa and 100 MPa. Compliance, however, can be built in using elastic moduli>1 GPa with effect shaping of the architecture within which the fibers are embedded or placed upon.

FIG. 22 is a flowchart of illustrative process 2200 for making and using a system for detecting applied force, in accordance with some embodiments of the present disclosure. Process 2230 includes assembling the system (e.g., such as system 2250, shown in cross-section), and process 2240 includes using the system (e.g., to determine force profiles, based on detected light signals 2252).

Step 2202 includes arranging processing equipment. In some embodiments, step 2202 includes mounting one or more PCBs to a structure. For example, step 2202 may include mounting PCB 1002 to structure 1001, as illustrated in FIG. 10. In some embodiments, step 2202 includes applying one or more fasteners to secure the processing equipment (e.g., a PCB) to the structure. In some embodiments, step 2202 includes applying one or more adhesives to secure the processing equipment (e.g., a PCB) to the structure. In some embodiments, step 2202 includes engaging one or more flexible tabs or other flexible features that are configured to secure the processing equipment (e.g., a PCB) to the structure.

Step 2204 includes installing a support enclosure. In some embodiments, a subassembly resulting from step 2202 is covered by a support enclosure. For example, the support enclosure may include two hemispheres, two mating enclosures, a plurality of enclosure elements, or any combination thereof that may be assembled to protect the processing equipment, provide an interface for a guide, provide structural support, or a combination thereof. To illustrate, referencing FIG. 10, step 2204 may include installing enclosures 1020 and 1021, illustrated as opposing spherical caps, to interface to structure 1001 and cover PCB 1002.

Step 2206 includes installing one or more guides. Step 2206 may include installing any suitable number of guides, which each may include any suitable number of channels or otherwise configured to direct any suitable number of fiber optic elements. For example, step 2206 may include any of the illustrative guides of FIGS. 2-7, or any other suitable guides, guide elements (e.g., having no channels), or any combination thereof. Step 2205 may include, for example, interfacing mating features, such as alignment features, of each guide and one or more support enclosures.

Step 2208 includes installing one or more fiber optic sensors. For example, step 2208 may include arranging a plurality of fiber optic sensors, in any suitable arrangement (e.g., to form a pattern or grid), in a guide. In some embodiments, step 2208 includes installing each end of each fiber optic sensor such that it may be coupled to an opto-electric device such as a light source or a light detector. In some embodiments, step 2208 includes arranging each fiber optic sensor along or otherwise as guided by channels of a suitable guide. Steps 2206 and 2208 may be performed in any suitable order or combined as a composite step. For example, fibers may first be installed in a guide and then the guide may be installed over a support enclosure. In a further example, a guide may be installed first over a support enclosure and then fibers may be installed.

Step 2210 includes applying one or more outer layers and features. In some embodiments, step 2210 includes applying an outer layer such that the assembled system resembles an object to be analyzed, such as a ball, tool, or other object subject to applied forces. For example, when the object is a sports ball, step 2210 may include applying rubber, leather, stitching (e.g., laces), wrappings, adhesives, any other suitable material or process, or any combination thereof to result in an instrumented object that is similar to the “real” object (e.g., an un-instrumented version of the object used during sports games).

Step 2212 includes calibrating the system sensors (e.g., using one or more calibration tools 2251). In some embodiments, step 2212 includes applying a known force or spatial and temporal field of force to the instrumented system, and recording the responses of the instrumented system (e.g., as measured by an ADC coupled to a plurality of light detectors). Any suitable calibration technique, schedule, and loading may be applied to determine calibration values (e.g., weightings, calibration constants, offsets, ranges, frequency responses, impedances, intensities, losses, or any other suitable values). Step 2212 may be repeated any suitable number of times, before or after use (e.g., use during process 2240). For example, the system may apply pressure uniformly across a surface of a grid of fibers. In an illustrative example, the calibration fixture (e.g., a pressure pot) may apply a known and uniform pressure over a plurality of pressure grids on respective plurality of instrumented objects, allowing calibration of the systems en masse (e.g., to generate a plurality of calibrations, one for each device, or by applying suitable ensemble averaging to generate a single or otherwise fewer calibrations). In some embodiments, for devices that are not sealed against hydraulic or pneumatic pressurization, a soft casing can be placed over them to seal against this pressurization while being calibrated (e.g., a calibration sleave to function as an outer layer).

Step 2214 includes receiving a force profile. In some embodiments, step 2214 includes the instrumented system being “used” by a user, who may apply forces to the system. In some embodiments, step 2214 includes directing an object to a target or backstop to record forces spatially and temporally during impact. In some embodiments, step 2214 includes applying a force to at least one fiber (e.g., of a plurality of fibers), where the force may have any suitable spatial character, temporal character, or both.

Step 2216 includes generating light signals using one or more light sources. In some embodiments, step 2216 includes generating a plurality of light signals and providing the plurality of light signals to respective fiber optic elements of a plurality of fiber optic elements. In some embodiments, the light signals may include electromagnetic radiation at any suitable wavelength or spectrum of wavelengths, and the light signals may be continuous, pulsed, modulated (e.g., based on a carrier wave, frequency modulation, amplitude modulation, phase modulation, shutter frequency, or other suitable modulation), or a combination thereof. For example, step 2216 may include controller 2111 providing a control signal to opto-driver 2112 to generate a plurality of control signals to each of a plurality of light sources (e.g., of light source(s) 2120).

Step 2217 includes detecting light signals using one or more light detectors. In some embodiments, step 2217 includes recording data from one or more light detectors indicative of the force profile. For example, as force is received, processing equipment of the system may record and store data in memory. Referencing FIG. 21, at step 2217, light detector(s) 2130 may detect a plurality light signals, as attenuated by fibers 2125, and generate a corresponding plurality of electrical signals (e.g., analog signals). Step 2217 may also include ADC 2115 receiving and sampling the plurality of electrical signals, and then memory 2116 storing the sampled data (e.g., transmitted a communications bus of controller 2111 or otherwise processing equipment 2110).

Step 2215 includes transmitting data (e.g., to one or more external devices). For example, data that is collected during step 2217 may be stored in memory and then transmitted to an external device for post-processing to determine forces, or other usage characteristics at step 2218. Step 2215 may be performed before, after, or concurrent with step 2217, depending on where processing of the stored data occurs, for example. Step 2215 may include transmitting data using any suitable protocol over any suitable physical layer (e.g., ethernet, WiFi), network topology, data link layer, device-device communications link (e.g., Bluetooth, USB, or other suitable link), any other suitable hardware, or any combination thereof. In some embodiments, step 2215 may include inserting and removing removable media via a port (e.g., using a USB memory drive or other portable media that includes memory storage). For example, step 2215 may include establishing a serial connection, establishing a TCP connection, sending UDP packets, establishing any suitable connection type, or any combination thereof.

Step 2218 includes determining one or more use characteristics of the system. In some embodiments, step 2218 includes applying one or more operations to transmitted data. Step 2218 may be performed by processing equipment of the instrumented system, an external device, or a combination thereof. For example, referencing FIG. 21, step 2218 may include filtering, normalizing, combining (e.g., forming new variables based on measured data), differencing (e.g., to determine derivatives or moments), summing (e.g., to determine integrals or weighted representative values), statistical analysis, applying machine learning, applying any other suitable processing, or any combination thereof on data collected from light detector(s) 2130 and sensor(s) 2140 stored in memory 2118 (e.g., and transmitted if processing occurs externally).

Step 2220 includes providing power via one or more ports to the system. For example, step 2220 may include charging a battery of the system. In some embodiments, step 2220 includes connecting a charging system (e.g., using a cable and connector) to a port of the system and providing power to a battery of the system. In some embodiments, step 2220 may be omitted. For example, a power supply of a system may have sufficient stored energy to facilitate measurements over a target time, and the power supply may be replaced (e.g., or removed and charged) after use.

In an illustrative example, process 2200 may include determining individual forces in a multitouch or multiple finger condition. Process 2200 may be implemented using any suitable approach including designing the fiber sensor array (e.g., at steps 2206 and 2208), varying the number of optoelectronics (e.g., at step 2202), applying patterned LED pulsing (e.g., at step 2216), and machine learning (e.g., at step 2218).

In a further illustrative example, process 2200 may be applied to an elastomer sensor arrangement to measure grip force and finger pressure over time, which may be used to provide valuable insights for any suitable sport or activity. For example, process 2230 may include assembling an instrumented baseball (e.g., system 100 of FIG. 1) that has the same or similar feel, dimensions, and aerodynamics as an un-instrumented baseball (e.g., a “regular” ball), but is configured to collect and transmit finger force data (e.g., wirelessly or via wired communication). To illustrate, a player or coach may use an instrumented ball in drills, catch play, bullpens, or pitch design sessions to understand how a player's finger forces affect ball trajectory and train them to manipulate their forces to obtain a desired trajectory. For example, step 2220 may include charging the ball wirelessly, as controlled (e.g., turned on or activated) using a switch, application, motion sensor, or a combination thereof. In some embodiments, the ball may be connected to or otherwise communicate with a software application wirelessly (e.g., using Bluetooth). In some embodiments, the light sources used to generate light signals at step 2216 may be automatically adjusted to a desired level, the ball may be calibrated for forces at step 2212, and then it would be ready for use (e.g., process 2240). In some embodiments, a software application may include, retrieve, or otherwise access predetermined parameters for sampling rate and triggers, to be executed by processing equipment 2110 at steps 2216 and 2217, that are used for a predetermined use case such as pitching a baseball, for example. For example, the parameters may be adjusted for different skill levels of players, type of data being collected, rate or speed of data being collected, sport type, any other suitable criteria, or any combination thereof. In some embodiments, data collection at step 2217 may start based on a manual prompt, automatic prompt, or a combination thereof, including someone pushing the start button on the application, setting an accelerometer trigger that collects data once a certain threshold is met, setting and using a predetermined velocity threshold, any other suitable technique, or any combination thereof. In an illustrative example, such as pitching, once the ball is ready to start collecting data the pitcher may pitch the ball as they normally would (e.g., for an un-instrumented system, during a game). The trigger may start data collection and record the data from ADC 2115 (e.g., from which finger forces are determined) caused by the pitcher throughout the course of their motion, and data collection at step 2217 may continue for a set amount of time after the trigger. In some embodiments, during and after recording, the data is transmitted at step 2215 via Bluetooth to a phone or tablet and then displayed on the application (e.g., as hosted or executed by an external device of external device(s) 2150). For example, the application may generate a display (e.g., at the external device or another suitable device) that includes data corresponding to the pitch flight, the finger forces in terms of quantities and locations on the ball, any other suitable data or determined values, or any combination thereof (e.g., as determined at step 2218). The data may be displayed, for example, in a table, as plots over time, as a 3-D pressure map of the ball that depicts the location of forces and how they change over time, any other suitable graphical representation, or any combination thereof. In some embodiments, data received or determined at step 2218 may be saved by the application in suitable memory storage such as memory of the external device, in the cloud (e.g., in memory of a server, for easy remote access), a removable drive, any other suitable local or remote memory storage device, or any combination thereof. In some embodiments, step 2218 may include side-by-side comparisons of different pitches or recordings to see how forces differed between them.

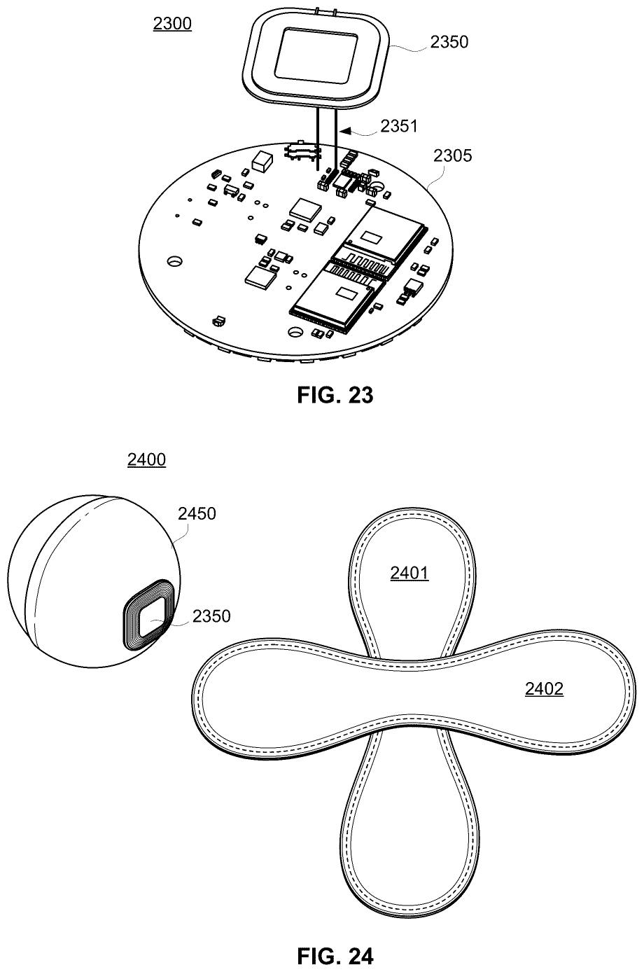

FIG. 23 shows a perspective view of illustrative processing equipment 2300 including a communications interface 2350, in accordance with some embodiments of the present disclosure. For example, as illustrated, processing equipment 2300 includes PCB 2305 and communications interface 2350 configured for wireless communication, coupled together by link 2351. To illustrate, processing equipment 2300 may correspond to processing equipment 2110 of FIG. 21, and communications interface 2350 may correspond to COMM 2114 of FIG. 21.

FIG. 24 shows a perspective view of components 2400 of an illustrative instrumented system, including processing equipment 2300 of FIG. 23, in accordance with some embodiments of the present disclosure. For example, the components of FIG. 24 may be assembled to form the instrumented system. Assembly 2450, which includes processing equipment 2300, light sources, light detectors, fiber optic sensors, and any other suitable components (e.g., guides, support enclosures, stitching), which may be covered with outer layer components 2401 and 2402 (e.g., leather outer portions of a baseball). For example, outer layer components 2401 and 2402 may be stitched together with laces over assembly 2450 (e.g., to form outer layer 2128 of FIG. 21). In a further example, communications interface 2350 may be configured to communicate through the material thickness of outer layer components 2401 and 2402 (e.g., although either layer may include a cutout to expose communications interface 2350, in some embodiments).

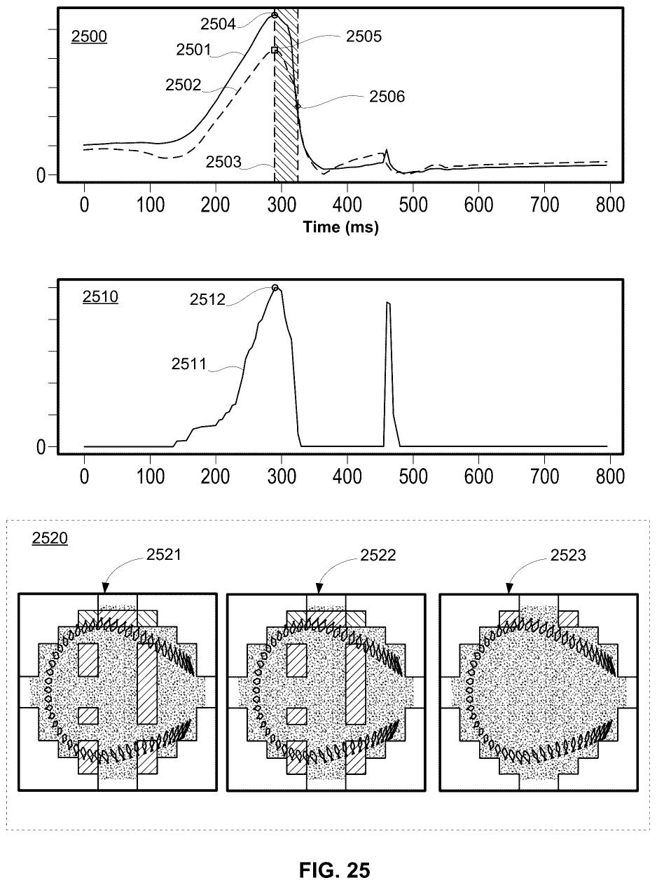

FIG. 25 shows illustrative plots of force information determined using an instrumented system, in accordance with some embodiments of the present disclosure. For example, the illustrative plots of FIG. 25 may be generated during step 2218 if process 2200 if FIG. 22. Plot 2500 includes an abscissa in units of time (e.g., milliseconds) and an ordinate in unites of relative pressure or force. Trace 2501 corresponds to a pressure or force over time for a location of “Finger 1,” and trace 2502 corresponds to a pressure or force over time for a location of “Finger 2.” Marker 2504 corresponds to a peak pressure of trace 2501, and marker 2505 corresponds to a peak pressure or force of trace 2502. Region 2503 corresponds to a finger release duration, over which the user's applied force is lessened (e.g., as the ball is thrown and eventually leaves the user's grasp). Marker 2506 corresponds to the release of the ball, as determined using any suitable criteria. Plot 2510 includes an abscissa in units of time (e.g., milliseconds) and an ordinate in unites of the sum of detected pressures or forces. Trace 2511 corresponds to the summed, integrated, or otherwise total pressure or force, over a suitable time, and marker 2512 corresponds to a peak total pressure or force experienced during the measurement event (e.g., the throw). Note that the second peak may correspond to the ball impacting a stop or other structure after the throw (e.g., imparting a force opposite to the direction of motion of the ball). Based on the force data, step 2218 may also include generating heat maps 2520 (e.g., laces are illustrated overlaid on heat maps 2520 merely for context). Heat map 2521 corresponds to the time of release of “Finger 1,” heat map 2522 corresponds to the time of release of “Finger 2,” and heat map 2523 corresponds to the time of release of the ball (e.g., marker 2506).

FIG. 26 shows an illustrative arrangement of fibers 2601-2605, in which the fibers to not intersect, in accordance with some embodiments of the present disclosure. For example, because fibers 2601-2605 do not intersect, light coupling between fibers may be prevented or otherwise limited. As illustrated, fiber 2601 follows a first path along a boundary of region 2611, fiber 2602 follows a first path along a boundary of region 2612, fiber 2603 follows a first path along a boundary of region 2613, fiber 2604 follows a first path along a boundary of region 2614, and fiber 2605 follows a first path along a boundary of region 2613. For example, a plurality of fibers may be included and distributed in regions 2611-2614, and may follow similar curbed paths (e.g., optionally including a change in direction, as illustrated). Fibers 2603 and 2605, for example, are arranged in or bordering region 2613. By arranging fibers along suitable paths, a system such as system 2100 may be able to localize force interactions. In some embodiments, the suitable paths may include particular regions on a surface (e.g., a target area), and the spacing of fibers may be any suitable distance to achieve a measurement resolution (e.g., a spatial resolution).

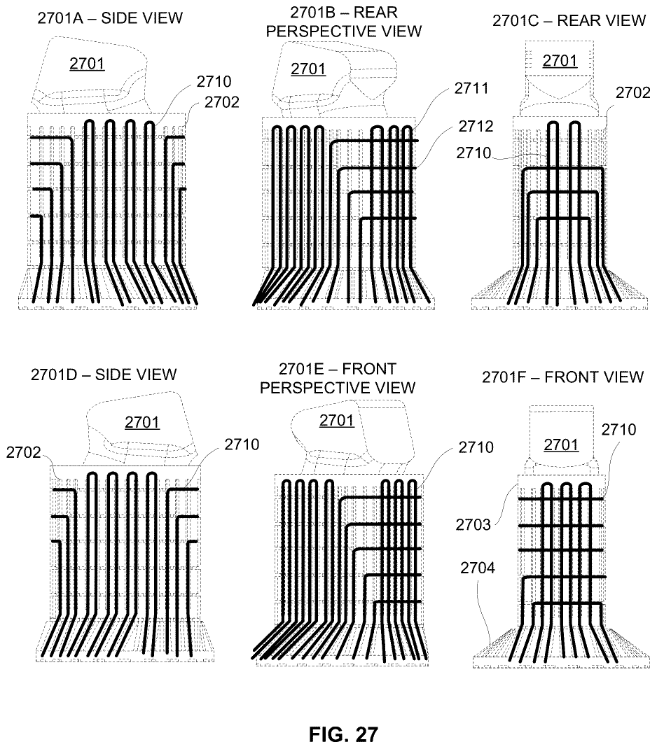

FIG. 27 shows an illustrative arrangement of fibers 2710 on an outer surface of handle grip 2701, in accordance with some embodiments of the present disclosure. FIG. 27 shows, for example, side view 2701A, rear perspective view 2701B, rear view 2701C, side view 2701D, front perspective view 2701E, and front view 2701F. In FIG. 27, handle grip 2701 is illustrated by dashed lines for purposes of clarity. As illustrated, handle grip 2701 includes channels 2702, arranged along handle 2703 and base 2704, in which fibers 2710 are arranged. Fibers 2710 include fibers 2711 that extend in vertical lines along handle 2703 (e.g., with a small turn-around loop to form two parallel paths), and also fibers 2712 that extend along both vertical and horizontal segments of the path, relative to the orientation illustrated in FIG. 27 (e.g., handle grip 2701 may be rotated or otherwise re-oriented). As handle 2703 is gripped, grip force may be detected over time, and spatially localized based on the paths of each fibers 2710 and the respective detected light signal (e.g., using light detectors 2130 of FIG. 21). To illustrate, handle grip 2701 may be part of a firearm, a racquet, a lever, any other suitable object that may be gripped and two which grip forces may be applied (e.g., to determine finger pressure measurements), or any combination thereof.

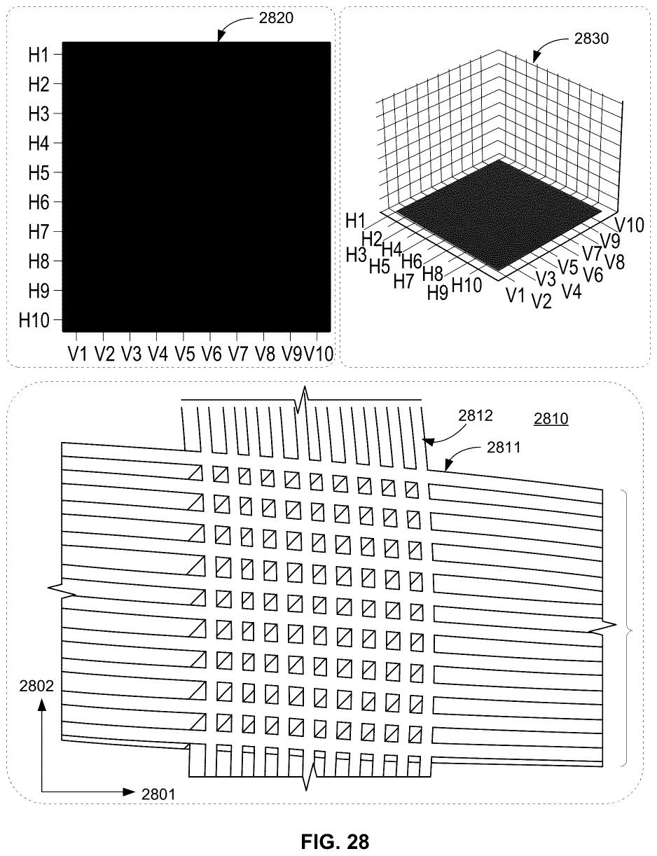

FIGS. 28-30 show a sequence of illustrative responses from a fiber grid arranged in a target region, including heat maps, in accordance with some embodiments of the present disclosure. To illustrate, a fiberoptic grid may be installed on an article of clothing (e.g., a shirt, helmet, hat, or other clothing item), and may be embedded under the surface of the object or arranged directly on a surface of the object. As illustrated, when a projectile impacts the fibers, the deformation may be localized in millisecond increments.

FIG. 28 shows target assembly 2810, having embedded fibers arranged in a grid, a with first plurality of fibers 2811 arranged in first direction 2801 and second plurality of fibers 2812 arranged in a second direction 2802 (e.g., at 90° to the first direction). FIG. 28 corresponds to a state prior to impact from the projectile, where the forces are zero (e.g., or near zero). Heat map 2820, and heat map projection 2830 (e.g., with height corresponding to local determined force), are generated based on detected light signals (e.g., indexed by H1-H10 and V1-V10, where “H” corresponds to first direction 2801 and “V” corresponds to second direction 2802). Heat map 2820 and heat map projection 2830 are relatively flat prior to an event (e.g., exhibiting a monotone color shading with negligible contour), as there are no appreciable changes in force.

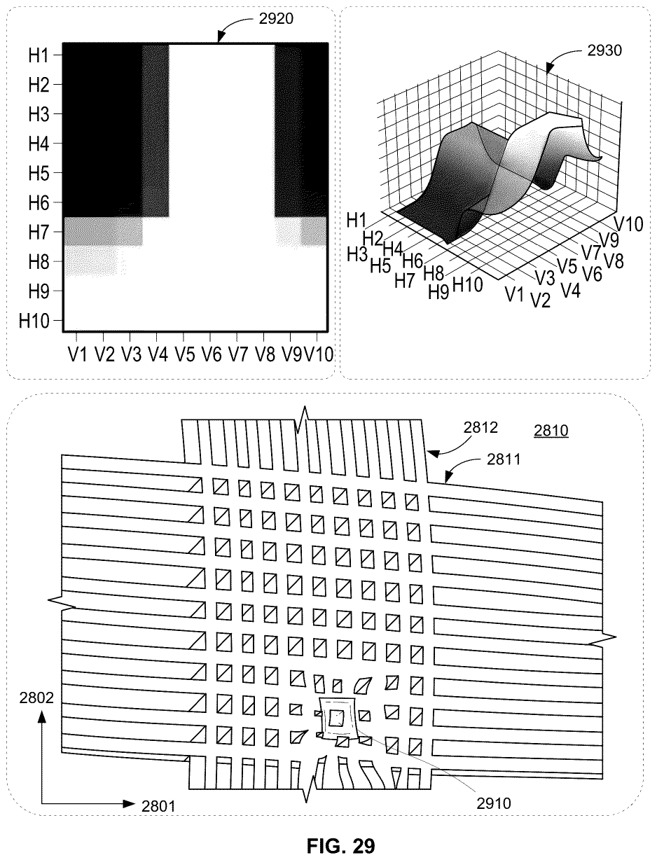

FIG. 29 shows target assembly 2810, corresponding to a state just after impact of the projectile, where the strain and detected force have a relatively large amplitude and is relatively localized at region of impact 2910. Heat map 2920, and heat map projection 2930 (e.g., with height corresponding to local determined force), show increased amplitudes of force as compared to FIG. 28, arising from impact of the projectile.

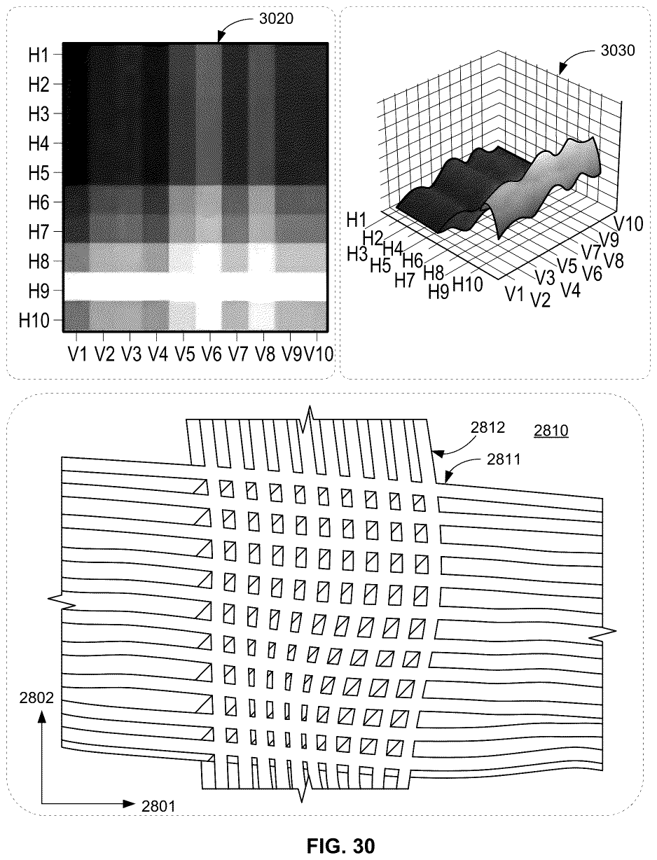

FIG. 30 shows target assembly 2810, corresponding to a state after impact of the projectile, where the strain and detected force have spread spatially and dissipated to at least some extent. Heat map 3020, and heat map projection 3030 (e.g., with height corresponding to local determined force), show increased amplitudes of force as compared to FIG. 28, but having a lesser peak than that of FIG. 29 as target assembly 2810 recovers from the impact.

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A system comprising:
a fiber optic element configured to be arranged in an object;
a light source configured to provide a light signal to the fiber optic element, wherein the fiber optic element attenuates the light signal based on a force applied to the object; and
a light detector configured to:
receive the light signal as attenuated by the fiber optic element; and
generate an output signal based on the received light signal.

2. The system of claim 1, further comprising a control unit coupled to the light source and configured to cause the light source to provide the light signal to a first position of the fiber optic element, wherein:
the light signal is a modulated signal; and
the control unit causes the light source to provide the modulated signal.

3. The system of claim 1, further comprising processing circuitry configured to:
receive the output signal from the light detector; and
sample the output signal at a rate of at least 1 kHz.

4. The system of claim 1, wherein the object comprises a graspable object.

5. The system of claim 1, wherein:
the light source is arranged at a first end of the fiber optic element; and
the light detector is arranged at a second end of the fiber optic element.

6. The system of claim 1, wherein:
the light source is arranged at a first end of the fiber optic element; and
the light detector is arranged at a position along the fiber optic element between the first end and a second end.

7. The system of claim 1, further comprising:
a guide configured to define a path of the fiber optic element, wherein the guide is configured to be arranged under an outer surface of the object.

8. The system of claim 7, wherein:
the guide comprises a channel;
the fiber optic element comprises a length; and
the channel is configured to accommodate the fiber optic element along the length.

9. The system of claim 1, further comprising:
processing circuitry coupled to the light source and to the light detector; and
a port coupled to the processing circuitry, wherein the port is configured to interface to an external system such that data may be transferred between the processing circuitry and the external system.

10. An apparatus comprising:
an outer surface;
a plurality of fiber optic elements arranged under the outer surface;
a plurality of light sources each configured to provide a respective light signal to a respective fiber optic element of the plurality of fiber optic elements, wherein the respective fiber optic element attenuates the respective light signal based on a force applied to the outer surface; and
a plurality of light detectors each configured to:
receive the respective light signal as attenuated by the respective fiber optic element; and
generate a respective output signal based on the respective received light signal.

11. The apparatus of claim 10, wherein each respective fiber optic element comprises a respective predetermined shape and is configured to attenuate a respective intensity of the respective light signal when the outer surface is gripped.

12. The apparatus of claim 11, further comprising a guide arranged under the outer surface, wherein the guide defines each respective predetermined shape.

13. The apparatus of claim 10, further comprising a guide comprising a plurality of holes configured to accommodate ends of the plurality fiber optic elements.

14. The apparatus of claim 10, wherein the plurality of fiber optic elements are arranged such that the force causes to be attenuated simultaneously a respective intensity of each respective light signal in a set of fiber optic elements of the plurality of fiber optic elements.

15. The apparatus of claim 10, wherein:
a first set of fiber optic elements of the plurality of fiber optic elements is oriented in a first direction;
a second set of fiber optic elements of the plurality of fiber optic elements is oriented in a second direction at a minor angle of intersection less than 90°; and
the first and second sets of fiber optic elements are arranged in a cris-cross pattern.

16. The apparatus of claim 10, wherein:
a first set of fiber optic elements of the plurality of fiber optic elements is oriented in a first direction;
a second set of fiber optic elements of the plurality of fiber optic elements is oriented in a second direction at a minor angle of intersection less than 90°; and
the first and second sets of fiber optic elements are arranged in a weave pattern.

17. The apparatus of claim 10, further comprising:
processing circuitry coupled to the plurality of light sources and to the plurality of light detectors; and
a port coupled to the processing circuitry, wherein the port is configured to interface to an external system such that data may be transferred between the processing circuitry and the external system.

18. A method comprising:
providing a plurality of light signals to a plurality of fiber optic elements arranged in an object using a plurality of light sources, wherein the plurality of fiber optic elements attenuate the plurality of light signals based on a force applied to the object;
receiving, at a plurality of light detectors, the plurality of light signals as attenuated by the plurality of fiber optic elements; and
generating, using the plurality of light detectors, a plurality of output signals based on the plurality of received light signals.

19. The method of claim 18, further comprising:
determining, using processing equipment, one or more force values based on the plurality of output signals, wherein the one or more force values correspond to the force applied to the object.

20. The method of claim 18, wherein:
an external device comprises first processing equipment;
the object comprises second processing equipment; and
the first processing equipment is configured to communicate with the second processing equipment, the method further comprising:
storing sampled data corresponding to the plurality of output signals in memory storage of the second processing equipment; and
transmitting the sampled data from the memory storage to the first processing equipment.
